(19) United States
(12) Patent Application Publication
(10) Pub. No.: US 2015/0324417 A1
(43) Pub. Date: Nov. 12, 2015

(54) RULES BASED DATA PROCESSING SYSTEM AND METHOD

(71) Applicant: VIDITECK AG, Zurich (CH)

(72) Inventors: Björn DANIELSSON, Sollentuna (SE); Ryan James ORSI, Kirkland, WA (US); Gregory POILASNE, El Cajon, CA (US)

(21) Appl. No.: 14/651,205

(22) PCT Filed: Dec. 9, 2013
(86) PCT No.: PCT/US2013/073815

§ 371 Date: Jun. 10, 2015

Related U.S. Application Data
(60) Provisional application No. 61/735,501, filed on Dec. 10, 2012.

(51) Int. Cl. G06F 17/30

(52) U.S. Cl. CPC G06F 17/30371

(57) ABSTRACT

Systems, methods and mediums are described for processing rules and associated bags of facts generated by an application in communication with a processing engine, database and rule engine that process the bags of facts in view of the rules and generate one or more rule-dependent responses to the application which performs one or more work flows based on the responses. The rule engine may apply forward-chaining, backward-chaining or a combination of forward-chaining and backward-chaining to process the rules and facts. Numerous novel applications that work in conjunction with the processing engine, database and rule engine are also described.

### CROSS-REFERENCE TO RELATED APPLICATION

This application claims the benefit of U.S. Provisional Patent Application No. 61/735,501, filed Dec. 10, 2012.

### TECHNICAL FIELD

The present disclosure relates to rules based data processing systems and methods for using the same.

### BACKGROUND

There have been recent developments in data collection, storage, access, and organization in cloud-based systems that have made possible an explosion in the amount of data attached to individuals and corporations throughout the world. When data sets grow so large that they become awkward to work with using traditional database management tools, they are termed “big data”. Big data is presently a macro, but growing issue, affecting larger corporations, which have enormous exposure to transactional data on a continuous basis, and other organizations attempting to process large amounts of data from disparate sources, such as a large metropolitan government attempting to process data from cars, sensors, cameras and many other sources to manage traffic flow on metropolitan roadways. As social networks, cloud services, and media services expand, the magnitude of data per person is already starting to grow to an unmanageable level by both computer systems and the individuals to which the data is directly or loosely coupled.

There are efforts currently underway that are focused on allowing individuals to easily query these enormous data sets that surround them, known as personal search engines. Personal search engines will be important to enable individuals to better search and organize their own very large collective data sets, however, there will still be a point at which the magnitude of the collective data sets become unmanageable from an individual's capacity and willingness to devote time and effort to the querying process.

Likewise, existing communication technologies, such as E-mail and text, have become overrun by marketing messages, a mix of personal and work correspondence, and other clutter. There has been a failure to adapt to the nature of modern individuals' communication styles which have evolved from short, single messages between a few recipients to a more fluid communication style among dozens of participants in different geographic locations wishing to share a plethora of content types in a highly contextual format. Incoming e-mail communications, for example, lack an effective ability to offer a user contextual relevance to the messages, i.e., every piece of communication coming in is fundamentally handled the same way with minor filtering capabilities. The result of increased magnitudes of collective datasets surrounding individuals and inadequate communication, organization software tools is massive inefficiency. Again, E-mail, which was once a clear, clean channel with which to communicate for personal and business reasons, has become cluttered and inefficient.

Many years ago Japan's Ministry of International Trade and Industry launched a 10-year project to develop the “Fifth Generation Computer”, which was supposed to boost performance by using massively parallel processors operating on large databases, such as big data. The software was to be based on logic programming (i.e. the Prolog family of languages) for two reasons: at the knowledge-representation level automated reasoning would be based on logic, and at the hardware level the declarative nature of logic would make it possible to automatically schedule computations among the huge number of processing units within a machine.

The fifth generation computer project was terminated in 1992 for a number of reasons; including the fact that conventional “off-the-shelf” computers had improved so significantly that they soon outperformed the parallel machines, and the committed-choice feature in the logic programming languages destroyed their declarative semantics. From a hardware perspective, the project was simply ahead of its time. As of April 2012, 8-core processors were standard “off-the-shelf” products, and mobile phones were equipped with 4-core processors. Computers with 16 or 32 processor cores will be the new normal in a few years. From a software perspective, the declarative semantics problem remains an issue today that is only magnified when declarative programming is run concurrently over multiple cores.

### SUMMARY

Systems and methods are described for processing rules and associated bags of facts generated by an application in communication with a processing engine, database and rule engine that process the bags of facts in view of the rules and generate one or more rule-dependent responses to the application which performs one or more work flows based on the responses. The rule engine may apply forward-chaining, backward-chaining or a combination of forward-chaining and backward-chaining to process the rules and facts. An embodiment of a combination of a backward-chaining rule with a forward-chaining rule within the rule engine may include the steps of utilizing a fact inferred from a forward-chaining rule as a goal for a backward-chaining rule, unless the forward-chaining rule contains a condition that depends on negation of another forward-chaining inference, in which case execution of the forward-chaining rule is suspended, the dependency of the rule-predicate for the problematic fact is recorded in a table, and execution of the forward-chaining rule skips to the next untried fact to select a new rule to execute. Numerous novel applications that work in conjunction with the processing engine, database and rule engine are also described.

### BRIEF DESCRIPTION OF THE DRAWINGS

FIG. 1 is a flow chart illustrating combined backward-chaining and forward-chaining rules with negation in accordance with an embodiment.

FIG. 2 illustrates a high-availability architecture in accordance with an embodiment.

FIG. 3 illustrates scaling by sharding in accordance with an embodiment.

FIG. 4 illustrates scaling by fragmentation in accordance with an embodiment.

FIG. 5A illustrates parallel forward-chaining in accordance with an embodiment.

FIG. 5B illustrates OR-parallelism in backward-chaining in accordance with an embodiment.

FIG. 5C illustrates AND-parallelism in backward-chaining.

FIG. 6 is a block diagram of an embodiment of an application development platform incorporating an embodiment of a rule engine.

FIG. 7 is a block diagram of an embodiment of data inputs for the application development platform of FIG. 6.

FIG. 8 is a block diagram of an embodiment of a database and process engine for use in conjunction with the rule engine of FIG. 6.

FIG. 9 is a block diagram of an embodiment of the rule engine of FIG. 6.

FIG. 10 is a block diagram of an embodiment of the processing section of FIG. 6 working in conjunction with an application.

FIG. 11 is a flow chart illustrating a high-level description of how an application works with the processing section of FIG. 10.

FIG. 12 is a flow chart illustrating a document management system in accordance with an embodiment.

FIG. 13 is a block diagram illustrating a computing device.

### DETAILED DESCRIPTION OF ILLUSTRATIVE EMBODIMENTS

An embodiment of a rule engine may contain the foundation of various application embodiments capable of enabling intelligent processing of data through processes and workflows in a way that context and relevance in the data is achieved regardless of size or complexity of the datasets. Accordingly, this description will start with a description of an embodiment of the rule engine and then describe various possible application embodiments involving the rule engine as a central element.

Embodiments of the present rule engine may comprise a computer readable medium having stored thereon instructions that when executed on a processor cause a processor to perform various functions, steps, algorithms, processes and the like. Further, the rule engine may be stored on non-transitory, non-transient, or computer readable storage media. As used herein computer readable storage media may comprise any disk or drive configured for the storage of machine readable information and may include floppy disks, CDs, DVDs, optical storage, magnetic drives, solid state drives, hard drives, or any other memory device known in the art.

Embodiments may offer several new possibilities to bring intelligent processing of data into workflows to the masses that is unique for each actor within the system and highly contextually relevant. In one embodiment, a process engine may use a rule engine's rules to control a process and rule facts to represent a process state. In this configuration, the programming may become pure logic and mathematically sound with little to no unwanted side effects or dead end process states. Process state-transitions may be based on conditions, not static flows, which make the system very good at handling highly complex datasets. The system processes may use asynchronous message passing that add fault-tolerance capabilities into the system and is well suited for scalability. Rule semantics can be made independent of execution order, allowing for parallel execution on multi-core CPUs.

An example of a rule engine in accordance with an embodiment, as compared to an existing rule engine, follows. The point behind comparing the present embodiment to an existing rule engine is to highlight the pure logic, declarative aspects of the present embodiment. The existing rule engine is called DROOLS; it is a popular open-source rule engine written in Java, sponsored by JBOSS (since 2006 a division of RED HAT). It is not purely declarative, and it is not quite as succinct as the present rule engine, as the following example illustrates: To code a rule that says “if the parent of X is Z, and the parent of Z is Y, then the grandparent of X is Y”. The corresponding DROOL code may be written as follows:

rule grandparent {

when

p1 : Parent( $x : child, $z : parent )
p2 : Parent( child == $z, $y : parent )

then

insert new GrandParent($x, $y);

}

The corresponding code for a present embodiment of the rule engine may be written as follows:
parent(X,Z) and parent(Z,Y)=>grandparent(X,Y);

Both of these code examples are purely declarative, but DROOLS allows code to be written using a different, non-declarative rule, such as follows:

rule grandparent {

when

$p1 : Parent( $x : child, $z : parent )
$p2 : Parent( child == $z, $y : parent )

then

insert new GrandParent($x, $y);
retract( $p1 );
Runtime.exec(“sudo /sbin/halt --poweroff”);

}

In the later DROOLS code, when the condition is triggered, the code first retracts the first parent-relation fact $p1 from the knowledge base (thus leaving the grandparent inference intact in the knowledge base while invalidating its logical support at the same time), and then the rule engine either turns off the computer, halts the virtual server (if the rule engine is operating in a cloud server environment), or causes some other fault to occur; all of which may be problematic for an application employing such a rule engine as any such fault may cause the application to hang and not complete a requested operation.

The same may not be the case with the corresponding code of the present rule engine embodiment because the declarative semantics cannot be destroyed. Further, by simplifying the code, the speed of the rule engine may be improved. A simple benchmark between a rule written using both rule engines illustrates such a performance increase. The benchmark rule measures only one specific function, the intersection between two sets of facts (known as an “inner join”) so as to avoid an apple to orange comparison. The DROOLS code may be written as follows:

rule “My Test Rule”

when

P($x : value)
Q(value == $x)

then

insert(new R($x));

end

The same rule expressed with the forward-chaining code of the present rule engine may be written as follows:
p(X), q(X)=>r(X);

DROOLS is a pure forward-chaining rule engine, but in embodiments of the present rule engine, this rule may also be written using a backward-chaining function, as follows:
r(X):=p(X), q(X);

In the benchmark tests, operating on the same computer with all other conditions equalized, the forward-chaining version was 41% faster for 200,000 facts and 2.8% faster for 400,000 facts. The backward-chaining version was 61% faster for 200,000 facts and 16.9% faster for 400,000 facts. The core operation of the present rule engine may be the same for both forward and backward chaining: the matching of facts; it is only the disposition of the inferences that differs.

The underlying structure of a rule engine may be comprised of one or more algorithms that drive the engine. Referring to DROOLS example again, DROOLS is based on RETE, a matching algorithm developed by Charles Forgy. RETE operates by building a tree from the rules established by the user. Facts enter the tree at the top-level nodes as parameters to the rules and work their way down the tree until they reach the leaf nodes, i.e., the rule consequences. More specifically, the tree includes a network of nodes, where each node (except the root) corresponds to a pattern occurring in the left-hand-side (the condition part) of a rule. The path from the root node to a leaf node defines a complete rule left-hand-side. Each node has a memory of facts which satisfy that pattern. As new facts are asserted or modified, they propagate along the network, causing nodes to be annotated when that fact matches that pattern. When a fact or combination of facts causes all of the patterns for a given rule to be satisfied, a leaf node is reached and the corresponding rule is triggered.

The present rule engine has a number of features, some of which are algorithmic, that may make it well suited for developing applications that can take advantage of its pure logic programming. These features (further described below) include:
A. Pure mathematical logic with no side effects;
B. Robust handling of negation;
C. Combined forward and backward chaining;
D. Succinct rule syntax;
E. The rule engine can be embedded in an application or provisioned as a service over the network;
F. The process engine represents each process state as a bag of facts which are true for the current state;
G. The process state-transitions are based on conditions, not static graphs with “flows” or “threads”; and
H. Processes use asynchronous message-passing.

With respect to feature A, a “side effect” refers to a non-logical element, such as reading files, writing files, etc., where the rule engine could get hung up. In order for a rule engine to be mathematical pure, it is necessary to remove such side effects. If a rule engine has no side effects, it only has logical elements, which means that when an embodiment of the present rule engine produces an output given an input, the result is consistent with the declarative semantics (the mathematical-logical interpretation) of the logic rules.

In contrast, for example, in PROLOG, side effects are handled within the rule engine itself, which is generally the case for parallel processing rule engines as well. In such rule engines, all process-state changes are done as database transactions. There are also rule engines, such as those used by certain insurance companies, where all data is structured in the form of process states so that all data is available to the rule engine without database transactions. Such rule engines do not permit, however, data to be partitioned and isolated so many different processes using the same data may be run in parallel, which impacts the efficiency of the rule engine and corresponding applications.

For rule engines with database transactions, collisions are always possible because different processes may, at the same time, attempt to request transactions, i.e., read/write all or part of the same data. A database transaction has the following property: at any point in time, from the point of view of any agent not directly involved in the transaction, either all or none of the changes associated with the transaction have occurred. This property guarantees that the system or systems that store the process state are always in a consistent state. All non-trivial database applications depend heavily on this property of transactions.

In order to guarantee this transactional property, databases use one of two schemes for concurrency control when multiple agents request transactions at the same time in a way that causes resource contention: pessimistic concurrency control; or optimistic concurrency control. Pessimistic concurrency control acquires exclusive locks on all resources that will be involved in the transaction, while optimistic concurrency control is free from locking, but detects update collisions only at the final commit operation, after all of the processing has been done. When a collision is detected, the current transaction is rolled back and re-tried, until it can be completed.

Optimistic concurrency control is the standard scheme for scalable web applications because it is more efficient for scalable applications with low levels of resource contention, i.e., it is optimized for the most common case, which is the assumption that there will be no resource contention. Any application using optimistic concurrency control needs to be able to re-try any transaction that failed due to an update collision. In very simple applications, this is easy—just encode the database update logic within a loop that repeats until the transaction can be committed successfully. However, this requires the database update logic operation to be an idempotent operation (i.e., an operation that remains unchanged when multiplied by itself), otherwise the semantics of the transaction will depend on whether a collision occurred or not, i.e., on physically random factors.

While the database transactions could be moved to a process engine working in conjunction with the rule engine to avoid collisions impacting the rule engine itself, in such a case, the rule engine would no longer be able to roll back the transaction that resulted in a collision resulting in hang ups as described above.

By having no side effects, computations by embodiments of the present rule engine are idempotent by definition—there are no side effects and there are not external inputs except those that are explicitly controlled by an embedding application. This is not the case for other programming languages, and while it is possible to write idempotent programs in any programming language, there is no guarantee that any give application will be idempotent. Hence, using an idempotent programming language as an embodiment of the present rule engine to compute process-state transitions may make it much easier to product transactional state transitions that are governed by completely general (i.e., Turing-complete) transition functions.

Feature A also enables algebraic tools to be used to prove the correctness of a set of rules, and to prove/derive properties that are implicit in that set of rules. For example, rules may be tested in isolation, in a “clean” lab environment. Any situation that can happen in a production environment may also be simulated (with little effort) in an isolated test. Feature A also has security benefits in that is internally consistent and requires no outside input to resolve a problem. Hence, the rules are self-authorizing. This feature makes it is safe to allow untrusted external parties to provide their own rules and to run whatever code they like in order to produce a result, e.g., personalized configurations within an application.

Feature B allows negative conditions to be used in a declarative way. For example, an embodiment of the present rule engine may use this feature to provide if-then-else rules in backward-chaining. Other backward-chaining languages (e.g., PROLOG) have if-then-else, but lack declarative semantics. Forward-chaining languages (i.e., most rule engines, such as the insurance companies' rule engines described above) do not have if-then-else rules due to the nature of the forward-chaining algorithm. The present rule engine can also use explicit negative conditions in forward-chaining, which relies upon the unique way forward and backward chaining are combined in the present rule engine, as further described below.

Feature C, the combining of forward-chaining with backward-chaining, provides more expressive power than either forward or backward chaining alone. Not only in the trivial sense of having both options, but also by combining them by having a forward-chaining rule produce a set of inferences that is reduced by a backward-chaining filter/search rule to provide a single answer, or by using a backward-chaining query as a part of a forward-chaining rule's condition.

Feature D makes the present rule engine more powerful than less succinct alternatives.

Feature E is a useful implementation feature that enables control of distribution of the rule engine without harming the performance of applications that rely on network implementations.

Feature F allows for a traditional Finite State Machine to be implemented in a trivial way, and for several concurrent Finite State Machines to be implemented in an equally trivial ways within the same process, and for any contextual data used by the process state-transition rules to be stored in the same bag together with the process state. Feature F also adds succinctness to stored process-specific data. The data is immediately available as facts to be used in rule conditions. No extra code to perform database retrieval is needed. Feature F guarantees that any formal analysis of the process state needs to take into account only this specific bag of facts.

Feature G simplifies the modeling of complex concurrent processes and Feature H is good for scalability and fault-tolerance.

Feature F may be particularly important in that by treating the process state as a “bag of facts” rather than as a finite state machine, procedural execution may be isolated from logical execution. Without the isolation of logic, there is no concept of logical rule-driven state transitions. And without distinct state transitions, the process state is (or could as well be) just a bunch of randomly updated database records. Hence, the group or

The features set forth above give embodiments of the present rule engine a number of advantages over existing rule engines. For example, the ability to test rules in isolation makes applications written to use the present rule engine easier to test, debug, and maintain rules. The security benefits, robust handling of negation, combined forward and backward chaining, and the succinct rule syntax gives the rule programmer more expressive power than with existing rule engines. The fact that the process engine represents each process state as a bag of facts, that process state transitions are based on conditions, and that processes use asynchronous message-parsing makes it easier to model complex concurrent processes, thereby making the applications that use the rule engine less expensive to produce and maintain. The ability to use algebraic tools to prove the correctness of a set of rules and the fact that any formal analysis of the process state only needs to account for the fact that a bag of facts is true for the current state, enables applications to use automated reasoning and proofs about rules to optimize processes and avoid errors. And, while other programming languages use pure mathematical logic, are succinct, and can be implemented in a network configuration, they are not rule engines.

As noted with respect to Feature C, the combination of forward-chaining and backward-chaining, as well as how negation is handled in forward-chaining rules, may be very powerful. Forward-chaining is “supply-driven”. It starts with individual given facts, and figures out what can be inferred from them via rules. A flight selection application based on an embodiment of the present rule engine may include a basic algorithm for implementing forward-chaining. For example:
if request (From, To) and nonstop (Flight, From, To) then candidate (Flight);

This rule needs some facts to work with, so assume the following facts:
request (“Stockholm”, “London”);
nonstop (“BA-0777”, “Stockholm”, “London”);

It should be noted in the example of rules provided herein, spaces have been added to make the rules easier to read. An explanation of the proper syntax for writing such rules is further provided below.

The forward-chaining rule set forth above may now infer the new fact candidate (“BA-0777”). The intended meaning of this inference is that flight number BA-0777 is a possible flight candidate for the request since it satisfies the conditions of the request.

A simplified embodiment of the present rule engine incorporated into a flight selection application may handle this forward-chaining rule as follows: For each fact in the give set of facts, i.e., request (“Stockholm”, “London”), the rule engine may look at each rule that contains some variation of request (X,Y) in the condition part of the rule (the antecedent), then may match this against the fact and may create an instantiation of the rule by constraining two of the variables, From=“Stockholm” and To=“London”. The rule instantiation may look like this:
if request (“Stockholm”, “London”) and nonstop (Flight, “Stockholm”, “London”) then candidate (Flight);

The rule engine may then inspect any remaining parts of the condition, in this case nonstop (“BA-0777”, “Stockholm”, “London”), for matches to the set of facts. In this case, one match is found since the given fact nonstop (“BA-0777”, “Stockholm”, “London”) matches. This match makes the rule condition true, and the inferred fact candidate (“BA-0777”) may be added to the set of facts. All inferred facts may also be tried against the rules in the same way as the given set of facts, so inferences and combinations of inferences may produce further inferences, and so on, and the algorithm may continue until there are no more untried facts to feed it with.

The flight selection application that invoked the rule engine may now inspect the final set of facts and look for any interesting inferences, or it may let the rule engine do the looking by running a backward-chaining query. Backward chaining is “demand-driven”. It starts from a hypothetical statement and figures out if the statement is a consequence of the rules. The statement may contain logic variables, and in that case, the statement might be true only for some particular values of those variables. The backward-chaining algorithm may then calculate those values. This makes backward-chaining suitable for querying a knowledge base.

In accordance with an embodiment of the present rule engine, backward-chaining rules may have a more complex structure than the forward-chaining rules. Instead of a number of separate “if-then” clauses, the “if-then” clauses in backward-chaining may be connected to each other via an “else” operator. This provides backward-chaining with a committed-choice feature with pure declarative semantics, which is distinguishable from existing logic programming languages that utilize non-logical commit and pruning operators.

Continuing with the flight selection example from above, if there had not been a nonstop flight that would take the user to the desired destination; it may still be possible to get there via a connecting flight. Backward-chaining may let us query the rule engine about possible connections, such as follows:

possible_flight (From, To, Flight) :=

if nonstop (Code, From, To)
then Flight = Code
else

if nonstop (Code1, From, Stop) and nonstop (Code2, Stop, To)
then Flight = [Code1, Code2];

Again, certain facts may be assumed for the example, such as:
Nonstop (“BA-0777”, “Stockholm”, “London”);
Nonstop (“SK-0903”, “Stockholm”, “New York”);
Nonstop (“BA-0273”, “London”, “San Diego”);
Nonstop (“UA-1726”, “New York”, “San Diego”);

If the backward-chaining engine is give the query possible_flight (“Stockholm”, “San Diego”, X), it may try to find a logical proof of this statement and provide one or more value for X. The backward-chaining algorithm may precede by instantiating the appropriate rule, using the goal parameters to bind variables in the rule, which may result in:
if nonstop (Code, “Stockholm”, “San Diego”)
then X=Code
else
   if nonstop (Code1, “Stockholm”, Stop) and nonstop (Code2, Stop, “San Diego”)
   then X=[Code1, Code2];

The next step may be to evaluate the condition of the first “if-then” clause, which may be done by invoking the backward-chaining algorithm using the condition as the goal, in this case nonstop (Code, “Stockholm”, “San Diego”). Since nonstop is an elementary fact predicate, the goal can be matched directly against the fact store. Since there is no nonstop flight from Stockholm to San Diego, no match can be found so the condition fails. The next alternative clause may then be tried (the one following the else). This condition is a conjunction of two elementary fact predicates. First nonstop (Code1, “Stockholm”, Stop) is matched in the same way as the first clause, and in this case two matches are found, giving the following corresponding variable bindings:
Code1=“BA-0777”, Stop=“London”
Code1=“SK-0903”, Stop=“New York”

Then nonstop (Code2, Stop, “San Diego”) is matched, non-deterministically since there are two values for stop from the first nonstop goal. One match is found for each of the stop values, and the total solution set for the conjunction is:
Code1=“BA-0777”, Stop=“London”, Code2=“BA-0273”
Code1=“SK-0903”, Stop=“New York”, Code2=“UA-1726”

At this point, the “if-then” clause is committed since its condition is true. This means that no more alternative “if-then” clauses may be considered for the goal. In this case there weren't any alternatives left anyway, but if there had been they may have been pruned. The original goal is now replaced with the subgoals in the “then” clause, and the backward-chaining algorithm may start again. This process may keep on until there are no more goals left to solve, or until one of the goals fail (causing the whole proof to fail). There is also a third possibility; a suspended proof due to one of several possible reasons, most notably conditions on values of variables that are never bound.

In the example of backward-chaining provided above, backward-chaining finished quickly since the subgoals that replace the original goal consist of the single goal X=[Code1, Code2]. This goal is not broken down further into subgoals since “=” is a built-in predicate that is evaluated by a procedure in the rule engine. The backward-chaining algorithm terminates successfully with two solutions sets for the original query:
X=[“BA-0777”, “BA-0273”]
X=[“SK-0903”, “UA-1726”]

Each of the X values corresponds to a different acceptable possible route from Stockholm to San Diego.

Ignoring non-determinism, naïve sequential backward-chaining (e.g., PROLOG) is very similar to the familiar stack-based execution model used to implement traditional procedural languages.

In accordance with an embodiment of the present rule engine, in the forward-chaining example above, the rule may be replaced with a rule that allows not only nonstop flights, but also connecting flights, such as:
if request (From, To) and possible_flight (From, To, Flight)
then candidate (Flight);
   Now the forward-chaining rule includes a condition that contains a backward-chaining query. The present embodiment makes the handling of this case simple, even though possible_flight (From, To, Flight) is a general query rather than a query of an elementary fact. In accordance with the embodiment, the input fact request (“Stockholm”, “San Diego”) will cause the goal possible_flight (“Stockholm”, “San Diego”, Flight) to be tried in the backward-chaining engine as part of the evaluation of the condition of the forward-chaining rule. As a result, the forward-chaining algorithm will add two new inferred facts to the set of facts:
Candidate ([“BA-0777”, “BA-0273”]);
Candidate ([“SK-0903”, “UA-1726”]);

Inclusion of forward-chaining inferences within a backward-chaining rule is almost as simple as the above. A backward-chaining goal may consist of any elementary fact, including any fact inferred from forward-chaining, hence it would appear that there would be nothing special about referring to the result of a forward-chaining rule from a backward-chaining rule, but this is not the case. There are issues that arise when a forward-chaining rule contains a condition that depends on the negation of another forward-chaining inference. To understand this, take the previous example rule, but add the extra condition of the flight not being cancelled, such as:
if request (From, To) and possible_flight (From, To, Flight)
and not cancelled (Flight)
then candidate (Flight);
   Then add an extra rule for cancelled (Flight) as follows:
If nonstop (Flight, From, To) and unsafe (Flight) then cancelled (Flight);
   The idea here is that any flight that has been deemed unsafe by the aviation authorities is automatically cancelled for flight selection purposes, even if the flight had not actually be cancelled.

The issue in the context of the embodiment is how and when to evaluate cancelled (Flight) so that it can be determined whether candidate (Flight) is true or false. An example of how this can be problematic is as follows: Assume that flight BA-0777 is not unsafe. Logically, this means that cancelled (“BA-0777”) would be false, since no rule implies that it is true and the rule engine works under a closed-world assumption. Therefore not cancelled (“BA-0777”) is true, which implies the fact candidate (“BA-0777”). The problem with this implied fact is that the truth-value of cancelled (“BA-0777”) cannot be computed until all possible applications of forward-chaining rules having cancelled (Flight) as the consequent, have been exhausted. It is not possible to know when all such rule applications have been exhausted, however, until the forward-chaining algorithm has completed.

The cause of the problem in the above example is the negative condition not cancelled (Flight). If all conditions depend only on positive facts, without negations, then the execution order of the rules is unimportant. Negations, however, make the forward-chaining algorithm order-sensitive. Hence, the seemingly simple forward-chaining algorithm has to be modified to handle the problematic rules in the correct dependency order.

An embodiment of the present rule engine, in runtime, detects attempts to use inferred facts in negations, and in fact any attempts to use them anywhere inside a backward-chaining rule, since the negation problem may also appear if the reference to the inferred facts is dynamically nested somewhere inside a negated goal. When this situation is detected, the current forward-chaining rule execution is suspended, the dependency of the rule-predicate on the problematic fact is recorded in a table, and the forward-chaining algorithm skips to the next untried fact to select a new rule to execute. An example of an order-dependency table may appear as follows:

| Predicate | Dependencies |
|---|---|
| candidate/1 | cancelled/1 |

There can be more than one dependency for a single predicate, but in this case candidate/1 has only the single dependency cancelled/l. Use of the term “/1” means a single-argument predicate. Predicates with the same name that have two, three or more arguments are considered separate predicates.

When all non-suspended forward-chaining has finished, the order-dependency table is scanned and all predicates that occur as dependencies, but don't have any dependencies themselves, are marked for closure, which in this context means that the closed-world assumption is now valid for these predicates, and they can be safely used in negations. Forward-chaining is then resumed for the rule executions that were previously suspended. Then the whole procedure may be repeated until one of two situations arises:
1. Forward-chaining has completed without suspending any rule executions; or
2. There are no dependency-free dependencies in the order-dependency table. In this case, all predicates in the order-dependency table are closed. This essentially amounts to making the closed-world assumption without knowing if it is valid, but this works because in cases where it is invalid, it will immediately be detected the first time an inference is made that was earlier assumed to be false within some negated condition, and the whole rule engine invocation is then aborted.
   For example, cancelled/1 will be closed since it has no order-dependencies of its own, and the suspected rule will finish in the next round of forward-chaining.

A more complicated example involves the rule for cancelled being replaced with:
if nonstop (Flight, From, To) and not approved (Flight) then cancelled (Flight);
   In this case, it is assumed that approved is also a forward-chaining inference, so the dependency table will now look like this, after the first forward-chaining run:

| Predicate | Dependencies |
|---|---|
| candidate/1 | cancelled/1 |
| cancelled/1 | approved/1 |

In this table, only approved/1 occurs in the table without having any dependencies itself. When the table is interpreted as a graph (mathematically a directed graph), approved/1 is the only leaf node. Thus, only approved/1 is closed before the suspended rule executions are resumed in a new forward-chaining run. Whereas cancelled/1 cannot be closed until it is known if any new cancelled/1 facts could be inferred by negations of conditions that contain approved/1. The second run will therefore suspend candidate/1 once again, but this time cancelled/1 is free of dependencies and can be closed. The third run will finish without suspensions and the forward-chaining algorithm will be completed.

As long as no cycles occur in the dependency graph, this forward-chaining algorithm will always handle negations successfully, i.e., it will never end up in situation 2 above. And, if cyclic dependencies do occur, situation 2 may still result in success, but it may also result in failure (aborted proof) since inferences might still be made that contradict the speculative assumption that the corresponding predicate could be closed earlier.

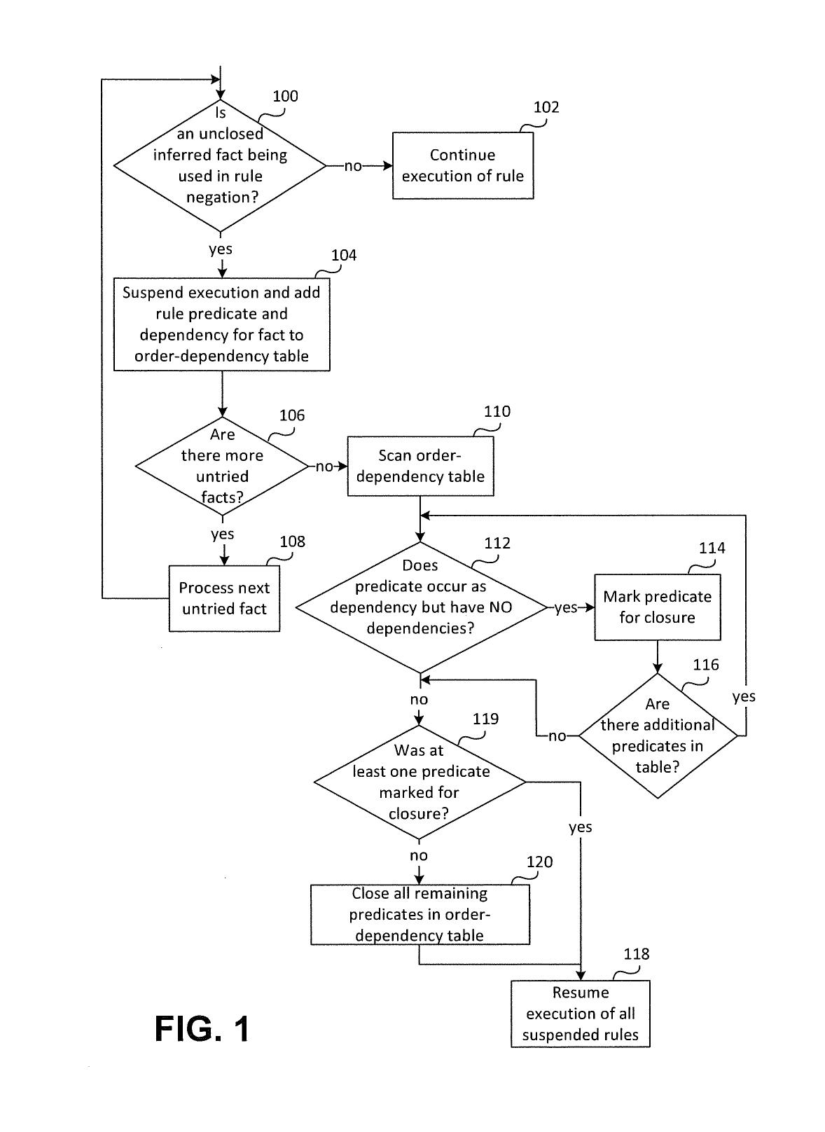

A flow chart illustrating forward-chaining rules with negation, or combined backward-chaining and forward-chaining rules with negation, as handled by a process engine working in conjunction with a rule engine, is illustrated in FIG. 1. In step 100, during run time execution of the rule, each predicate encountered inside a negation is checked to determine if it is marked as inferred, but not yet closed (there is a flag indicating such in the rule engine's symbol table). If not, the rule continues to be executed as normal, step 102. Otherwise, the rule execution is suspended for that fact that being tried (the triggering fact for the current rule execution) and the predicate of the rule and its dependency is added to an order-dependency table, step 104. In step 106, if there are more untried facts, the next untried fact is tried against all rules, step 108, and in accordance with step 100. If all of the facts have been processed to completion according to the rule or suspended in step 104, the order-dependency table is then scanned, step 110. If a predicate is listed in the table, but has no dependencies, step 112, the predicate is marked for closure, step 114. If there are additional predicates in the table, step 116, the process returns to step 112. If there are no additional predicates, in step 119, a check is performed to determine if any (i.e., at least one) predicates have been marked for closure (i.e., step 114 was performed zero times in that loop), and if no predicate was marked for closure, all remaining predicates in the order-dependency table are closed, step 120. If at least one predicate was marked for closure at step 119, then execution of the suspended rules is resumed in step 118.

While the combined forward-chaining and backward-chaining rule (with negation), may appear fairly simplistic, this particular combination is not insignificant. As noted above, the insurance company solutions only used forward-chaining, while the Fifth Generation Computer project only used backward-chaining. Forward-chaining is data or event driven while backward-chaining is good for calculations where you have a goal and need a solution. Forward-chaining preprocesses facts to produce inferences, while backward-chaining seeks to find the best solution given the facts. Combining the rules allows the powers of both rules to be harnessed. For example, with the combined rules, facts can be applied to a backward-chaining rule or a forward-chaining rule without otherwise using a backward-chaining rule or forward-chaining rule itself. Combining the rules in this manner through a process engine that handles the negation issue discussed above, has not been done, and the result is extremely powerful, yielding many of the desirable features noted above.

In order to utilize embodiments of the rule engine described above, it is now necessary to understand more about its semantic details and how it can be used. In the construction of rules and facts, facts are represented formally as predicate symbols together with zero or more arguments. Examples include:
holiday
amount(170)
service(takeout)
location(“Sundbyberg”)
depends(margherita,basil)

The meaning of such formalized facts depends on the intended human interpretation. This interpretation involves decisions about formal or informal vocabularies and local or global conventions for how to abstract relational expressions into predicate symbols. Using the examples above:

“holiday” could mean: today is a holiday

“amount (170)” could mean: the order amounts to 170 units of currency

“service (takeout)” could mean: the customer picks up a prepared meal for consumption elsewhere

“location (“Sundbyberg”)” could mean: Sundbyberg is the location where the customer wants the ordered item delivered

“depends (margherita, basil)” could mean: pizza margherita depends on the availability of fresh basil.

Predicate symbols are not restricted to strings of letters. More descriptive strings can be used, either by using underscore characters that separate words, or by enclosing the whole strings in either single or double quotes:
delivery_location_is(“Sundbyberg”)
“today is a holiday”
‘pizza type depends on fresh availability of’ (margherita, basil)

This can sometimes contribute to increased clarity, but the extra code bloat and loss of abstraction can easily negate all positive effects. In the end it's a judgment call for which the programmer is ultimately responsible.

The arguments of a predicate represent the objects that the corresponding fact is “talking about”. For example, the fact amount(170) says something about the number 170, i.e., it is the amount of the order. And, the fact depends(margherita,basil) says something about the pizza type margherita and the herb basil. Formal logic doesn't really care about what the symbols margherita or basil means, and in its most pure form logic doesn't even care about what 170 means. The idea that it is an ordinary number is just one of many possible interpretations. The only thing that matters in pure formal logic is how various expressions of truth are related to other expressions of truth, where the fundamental truths are taken for granted as axioms or as contingent truths describing empirical observations. Therefore all objects are simply represented as abstract symbols, either as symbolic constants (atomic terms) or as functions of other object representations. This abstract representation of objects is known as “Herbrand terms” after the French mathematician Jacques Herbrand who invented them in the 1920s.

The set of Herbrand terms is defined recursively:

1. Any constant symbol is a Herbrand term. Examples: foo, x, 42, −3.14, “I am the walrus”.

2. A function symbol applied to a list of Herbrand terms is also a Herbrand term. Examples: foo(bar), f(a,b,c), f(g(a,f(b)),c).

Function symbols and constant symbols have the same syntax as predicate symbols (as described in the previous section). Please note that symbols that begin with an upper case letter or underscore are interpreted as logic variables, so such names cannot be used for constant symbols, function symbols, or predicate symbols, unless they are quoted.

From a programming perspective, compound Herbrand terms with arguments may be viewed as constructors for generic data structures, a type of isomorphism that is common in other types of languages. It should also be noted that a zero-argument predicate is just an atomic proposition from a logical perspective. Even though such propositions generally talk about objects in some semantic interpretation, this circumstance is completely invisible in a formal context, and in this context the propositions are for all intents and purposes opaque. Predicate logic that involves only zero-argument predicates and nothing else, is in all respects equivalent to propositional calculus.

Some facts, rules, and terms may be written with operator notation instead of the normal functional notation, e.g. as x op y instead of op(x,y), or op x instead of op(x). This is pure syntactic sugar which has no relevance whatsoever as far as the semantics are concerned. For example, the Herbrand term sqrt(3**2+4**2) is in all respects except superficial syntax completely equivalent to the Herbrand term sqrt(‘+’(‘**’(3,2),‘**’(4,2))).

All operator symbols are predefined, and their names and precedence relationships can be found below. Built-in operator symbols make it easy to write arithmetic formulas in the way they are normally expressed. However, in pure predicate logic there is no automatic interpretation of such formulas. Evaluation of arithmetic formulas only occurs in a specific set of “arithmetic aware” built-in predicates: eval, <, etc. And, the unification predicate ‘=’ is only concerned with the structure of Herbrand terms, so for example 2+2=4 is actually false since ‘+’(2,2) and 4 are two distinctly different Herbrand terms. However, eval(2+2,4) is true, since eval maps arithmetic expressions to numeric values.

Rules are expressed using pure predicate-logic. Technically speaking, rules are represented by a form of logic sentences called first-order Horn clauses over the domain of Herbrand terms. This means that each and every rule has a logical interpretation that is well-defined and independent of any specific rule engine implementation or any particular encoding. It also means that invocation of the rule engine can never have any side-effects, and that all expressions within the rules have referential transparency.

The reasons for using first-order logic and Horn clauses are that this combination makes rule resolution mathematically and computationally tractable. There are efficient proof algorithms for first-order Horn clauses, and it is known that purely propositional Horn clauses can be proven in polynomial time. The pure Horn clause model is extended with negation-as-failure together with if-else-logic, and there are also a number of built-in predicates whose first-order interpretation can only be understood as infinite axiom schemas. However, none of these extensions have semantics that deviate from pure logic in any way.

There are two general reasoning methods used by embodiments of the present rule engine: forward-chaining and backward-chaining, as described above. In forward-chaining, the rule engine starts with a set of base facts, then finds the rules that have conditions matching those facts, and makes inferences from the rules. These inferences are then taken as new facts, and the process is repeated until no new inferences are made, or until some rule infers false, which signifies a logical contradiction. In backward-chaining, the rule engine starts with a query, expressed as a predicate which may contain variables. This predicate is assumed to be either a base fact or an inference from a rule, and the rule engine then finds out under what conditions this predicate is true. If the predicate matches one or more facts, these facts constitute the answer to the query. If the predicate matches an inference from a rule, each condition for that rule is treated as a backward-chaining query, and the answer to the query that invoked the rule will be the set of solutions that is common to all the conditions. The language described herein provides support for both forward and backward-chaining, by using notation that specifies which method to use for a particular predicate. Each predicate is specified either by forward-chaining rules or by backward-chaining rules, and these are syntactically distinct. There is also a third type of predicate: fact predicates that are specified by a set of base facts.

Forward-chaining rules are written with the predicate-to-be-defined on the right and the conditions on the left, as follows:
if aquatic(X) and hasGills(X) then fish(X);
if mudskipper(X) then fish(X);
   or alternatively the implication symbol (“=>”), can be used, as follows:
aquatic(X), hasGills(X)=>fish(X);
mudskipper(X)=>fish(X);

If the above definition of fish/1 (i.e. the predicate named fish with one argument) is in a context where the base facts aquatic(nemo) and hasGills(nemo) are true, forward-chaining will infer the fact fish(nemo) and add it to the set of proven facts. This new fact is then treated as if it were a base fact, triggering all forward-chaining rules that contain fish(X) in their conditions, if any such rules are present.

Forward-chaining is very useful for taxonomy (classification) of something that can be described by a relatively small set of facts. The above example shows only two inference rules, but in a more complex scenario there could be many thousands of classification rules. In such a case, forward chaining guarantees execution times proportional to the number of rules whose conditions contain only those predicates that are present in the small set of facts, rather than the total number of rules. This is quite different from backward-chaining, which is described below.

Backward-chaining rules are written with the predicate-to-be-defined on the left and the conditions on the right, as follows:
connected(A):=if A=roma then true
   else link(A,B) and connected(B);

Alternatively, the same predicate definition can be written using two long-arrow (“-->”) clauses, as follows:
connected(roma)-->true;
connected(A)-->link(A,B), connected(B);

The predicate connected/1 is true for all nodes in a network that are connected to the node named roma. Direct links between nodes are given as base facts, as follows:
link(napoli,roma);
link(firenze,roma);
link(bologna,firenze);
link(genova,firenze);
link(milano,genova);
link(milano,torino);
link(venezia,bologna);

To answer the query connected(milano), referencing back to the clauses above, backward-chaining will start by matching the query against the definition of connected/1. The first clause does not match because roma and milano are two distinct constant symbols. But, the second clause matches with A=milano, producing two new queries link(milano,B) and connected(B). The first of these queries determines the possible values of B, which in this case are B=genova and B=torino. This leads to two alternatives for the remaining query: connected(genova) and connected(torino). Backward-chaining is applied to both of these alternative queries, and the first one produces connected(Firenze) which in turn produces connected(roma) which matches the first clause in the definition of connected/1, producing the query true, which ends the chain of proof.

Backward-chaining is very useful for searches and decision-making, and it is especially efficient when the rules have relatively few cases and the number of facts is large. In the above example, adding a couple of million extra link/2 facts would not affect the execution time at all for the original query, as long as none of these extra facts are needed for the proof of the query. This is quite different from forward-chaining, where all facts are matched against the rules, regardless of whether they are needed or not.

For backward-chaining rules, the defining clauses are always mutually exclusive. This is by design: for each clause, all choice conditions for all the previous clauses are implicitly negated. This restricts the semantics compared to languages that use arbitrary Horn clauses for backward-chaining. The benefits of this design are explained below relative to the description of “deterministic-choice logic”.

Backward-chaining definitions are also useful for computing values. For example, if the link facts listed above were extended to include the distance between the linked nodes, such as:
link(firenze,roma,300);
link(genova,firenze,270);
link(milano,genova,150);

The distance to roma from another node can then be computed by the following predicate:
distance(roma,X)-->X=0;
distance(A,X)-->link(A,B,Y), distance(B,Z), X=Y+Z;

The answer to the query distance(milano,X) will be computed via backward-chaining to be distance(milano,150+270+300+0). As discussed above, X=Y+Z does not perform any arithmetic, it just unifies Herbrand terms. Accordingly, the solved value for X is the compound term 150+270+300+0 rather than the symbolic constant 720. In order to calculate the latter, the definition must use eval/2 to evaluate the sum:
distance(roma,X)-->X=0;
distance(A,X)-->link(A,B,Y), distance(B,Z), eval(Y+Z,X);

It is not possible to mix the different types of definitions for the same predicate. For example, if foo/3 has a backward-chaining rule, there cannot also be a forward-chaining rule that has foo/3 as its consequent.

However, it is possible to use a forward-chaining predicate in a backward-chaining query, and it is also possible to use a backward-chaining predicate as a condition in a forward-chaining rule. The first case is fairly straight-forward: when all forward-chaining inferences have been made, the forward-chaining predicates look just like base facts in a backward-chaining context, and may be used in the same way as base facts are used.

The second case is slightly more complicated. A backward-chaining query may be mixed among the conditions in a forward-chaining rule, for example as follows:
departure(X),distance(X,Y)=>travel(Y);

Assuming the base fact departure(milano) and a backward-chaining definition of distance/2, this rule will calculate Y via backward-chaining, giving, e.g., 720, and then make the forward-chaining inference travel(720) as described above regarding the combination of forward-chaining and backward-chaining.

Non-determinism is when a single invocation of a rule can produce more than one possible answer. For example, assume the following base facts:
depends(margherita,basil);
depends(margherita,tomatoes);
depends(capricciosa,artichokes);

The query depends(X,Y) will produce three combinations of values for X and Y:
X=margherita, Y=basil
X=margherita, Y=tomatoes
X=capricciosa, Y=artichokes
   Similarly, the query depends(margherita,X) produces two values for X:
X=basil
X=tomatoes
   The query depends(capricciosa,X) on the other hand has a single unique answer: X=artichokes. And the query depends(X,anchovies) has no answer at all. Such cases are called deterministic, since there are no alternative outcomes that need to be considered.

The ability to do non-deterministic queries is both powerful and dangerous. It is powerful since it makes it easy to express conditions that depend on a match between two or more facts. Take for example the rule:
supplies(Seller,Goods), demands(Buyer,Goods), licensed(Seller)=>trade(Goods,Seller,Buyer)

This rule matches all licensed sellers of goods with all buyers of the goods offered, according to the fact predicates in the condition part of the rule. For all matches found, a set of trade/3 facts are produced as inferences. All of this is done by a single line of code. The dangerous part is that it is very easy to write deceptively simple rules that require intractable amounts of work to resolve due to unexpected non-determinism—getting multiple sub-query answers each of which is matched against more multiple answers, causing a combinatorial explosion. The remedy for this non-determinism is deterministic-choice logic, which is further explained below.

Negation makes a true sentence from a false sentence, and a false sentence from a true one. Negation is only supported herein in a limited format, due to restrictions in the underlying resolution procedure. Most notably, base facts and inferences can never be negated. They must always be positive. E.g. it is not legal syntax to write:
not mudskipper(nemo);
hasGills(X)=>not mammal(X);

The other limitation is that the proof of a negation can never assign values to variables, for which there is a good reason. For example, assume that some condition contains as one of its parts “not depends(margherita,X)”. This could theoretically be proven true with an infinite number of solutions for X:
X=anchovies
X=3.14
X=f(a,b) X=f(a,f(a,b))
X=“I am the walrus”
X=f(a,f(a,f(a,b)))
. . .

But doing so is clearly impractical, so the only situations where the negation not depends(margherita,X) can be resolved are the following:
1. X is assigned the value anchovies by the proof of some other part of the condition. Since there is no fact stating depends(margherita,anchovies), the negation is proven true.
2. X is assigned the value basil by the proof of some other part of the condition. Since there is a fact stating depends(margherita,basil), the negation is proven false.
3. There are no facts at all that match depends(margherita,X). The negation is therefore proven true for all X, so no value needs to be assigned.
4. Instead of being a fact, depends/2 is defined as a predicate that is true for all X, e.g., depends(margherita,X)-->true; The negation is therefore proven false for all X, so no value needs to be assigned.

In all other cases the proof of the negation will be suspended. The condition that contains the negation may still be proven false due to some other part of the condition being false, but any proof that depends on the condition being true will be suspended also, possibly resulting in a suspended proof for the top-level query.

It should be noted that negative facts can sometimes be “emulated” by introducing a few extra predicates and rules. For example, if a rule uses a fact predicate accepted(X), another fact predicate not_accepted(X) can be introduced to represent the negated case. Since this is formally a positive fact, it can be used in rules without restrictions. To avoid inconsistencies in the interpretation, rules of the following form may be added:
accepted(X) and not_accepted(X)=>false;

Whenever “false” is inferred, the proof is aborted and the detection of a contradiction is signaled to the embedding application.

The same technique can be extended to handle any set of facts which are collectively exclusive, e.g.,
lights(red) and lights(yellow) and lights(green)=>false;
   A contradiction error will be signaled if the left-hand condition is true.

Deterministic-choice logic is when a predicate is defined by several clauses in such a way that at most one of the conditions can be true simultaneously. For example, if something is to be categorized into one of the categories standard, gold, or platinum, depending on the truth-values of the facts good, better, and best. One might try the following approach:
good=>category(standard);
better=>category(gold);
best=>category(platinum);

However, this will not work as expected if, for example, both good and better are simultaneously true, since two facts will then be inferred: category(standard) and category(gold). Since only the second of these is desired, the conditions need to be made more precise, as follows:
best=>category(platinum);
better, not best=>category(gold);
good, not better, not best=>category(standard);
   Each clause now negates the conditions of the preceding clauses. This can be expressed in a more readable way as a backward-chaining predicate using the if-then-else syntax:
category(X):=if best then X=platinum
   else if better then X=gold
   else if good then X=standard;

This shows the logical meaning of “else”: it is a connective that implicitly negates the previous condition. All backward-chaining predicate definitions set forth herein use deterministic-choice logic via “else”. This applies to predicates defined by the “-->” syntax as well. The above example looks like this in the arrow syntax:
category(X): best-->X=platinum;
category(X): better-->X=gold;
category(X): good-->X=standard;
   There is an implicit “else” between each clause and the next one. The condition between the colon (“:”) and the arrow (“-->”) is called a guard. No attempt is made to resolve the remainder of the clause (to the right of the arrow) until the guard is proven true.

If the predicate arguments contain pattern-matching terms, this pattern matching is technically also part of the guard. If no colon-delimited condition is present, the guard consists only of argument pattern-matching.

The proof of a guard can never assign values to variables that are external to the guard. For example, assume the following clauses and base facts:
security(X,Y): trusted(X)-->Y=high;
security(X,Y)-->Y=low;
trusted(alice);
trusted(bob);
   Logically, security(P,low) is true for all values of P that are different from alice and bob, but such values cannot be produced by a proof in any practical way, for exactly the same reasons as the ones described above relative to negation. Accordingly, the proof of the guard is suspended, and as a consequence the answer to the query is a suspended proof, unless the query is part of some bigger query where a value is assigned to P by some other part of the proof.

In some cases, the limitation that guards cannot assign values to external variables can be overcome by introducing an extra variable which is free within the guard of the first clause:
security(X,Y): trusted(Z)-->X=Z and Y=high;
security(X,Y)-->Y=low;
   Here the choice between the first and second clause is made without having to assign any value to the P in the query. If the first clause is chosen, P may be assigned a value via X=Z, or several values non-deterministically (e.g. alice and bob). But the semantics are changed: security(P,low) is now true only if trusted(Z) is false for all Z, i.e. when there are no trusted/1 facts. When this is the case, no value is assigned to P since security(P,low) is then true for all P.

The benefit of always using deterministic-choice logic in backward-chaining is that it guarantees that non-determinism is never introduced by trying clauses during backward-chaining. Non-determinism may still occur via fact queries, but those cases are much easier to predict and recognize. Using fact queries is also the recommended way of writing backward-chaining rules where non-determinism is explicitly desired. Forward chaining does not use deterministic-choice logic. It would make no sense since the clause conditions are not tested in any predictable order during forward chaining.

In theory, if-then-else is not the only possible way to accomplish deterministic choices. Another possibility is N-way exclusive-or, and there are many other ones. However, if-then-else is familiar to everyone, and it has the advantage that the proof algorithm can be implemented very efficiently.

The “closed-world assumption” is the assumption that anything that is not known or proven is false. This assumption is reasonable in formal contexts where rules and data are by definition “complete” for the purpose at hand. For example, a company may have records of debtors that owe the company money. It is reasonable to treat everyone formally as a non-debtor who is not found in the company's records of debtors, even if there is a possibility that people may exist who owe money, but who haven't been recorded as debtors. In present embodiments, the closed-world assumption is necessary for proving a negation true, and (equivalently) for proving a guard false. Other than that, the closed-world assumption makes no difference.

Since negation and deterministic-choice logic such and powerful tools, the closed-world assumption is implicitly made for all predicates the opposite assumption is specified. The opposite is called the “open-world assumption” and present embodiments have a special declaration for it, which can be used for predicates that are exempt from the closed-world assumption. For example:
meta {open_world_assumption a/1, b/0;};
meta {open_world_assumption c/2;};
a(foo);
c(foo,bar);
e(foo);
   Given the above declaration and facts, the queries a(bar) and c(foo,baz) will give rise to suspended proofs, as will the query b since there is no fact b present, but will not give rise to the conclusion that b is false due to the fact it is an open-world fact. The query d on the other hand will be proven false, as will the query e(bar).

Only facts and forward-chaining predicates may be declared as open-world. Backward-chaining predicates are always closed-world, since they use deterministic-choice logic, where predicate definitions are always complete. Syntactically, the open-world declaration is tagged by a meta statement, as shown in the example. The complete list of meta statements can be found below.

In order to make it easier to build complex systems from simple parts, the rule syntax of the present rule engine has built-in support for namespaces. Each symbol really consists of two parts: a namespace prefix, and a local name. For example:
foo::bar
   In the above example, the namespace prefix is foo and the local name is bar. When no namespace is given, an implicit namespace is supplied. The default implicit namespace is main, so in the following case:
bar
   The symbol bar will be interpreted as main::bar.

This implicit namespace can be changed by adding a namespace declaration to the code:
meta {namespace foo;};

Any mention of bar after this declaration will be interpreted as foo::bar. And the same goes for any other symbol, e.g. baz, mentioned after the namespace declaration.

But it is also possible to change the implicit namespace for just one particular symbol. This is done through an “import” declaration:
meta {import foo::bar;};
   In this case, any mention bar will be interpreted as foo::bar, but all other symbols will get the namespace main unless some other namespace has been specified by a namespace declaration. No special declaration is needed in order to introduce a new namespace. If, for example, asdfghj::some_symbol is written, this symbol will have the namespace asdfghj regardless of whether or not “asdfghj” is mentioned anywhere else. But there are four namespaces that are handled differently herein, which are:

| | |
|---|---|
| Main | The default implicit namespace. |
| Core | Symbols used by standard built-in predicates |
| | have this namespace. These symbols are |
| | always imported before user code is parsed. |
| Sys | Symbols used by code that implement the |
| | core predicates, and by other utility code. |
| | These symbols are not imported unless |
| | explicitly requested by user code. |
| Process | Symbols used by code specific to the process |
| | engine. Some of these symbols are pre- |
| | imported in process code, just like the |
| | core symbols are imported in the general |
| | case. |

These four namespace tags should be avoided when naming private namespace. It should be noted that imports are just instructions to the parser that certain symbols shall be renamed. If a user what wants to use a symbol such as eval for a predicate definition, despite the fact that eval is normally pre-imported from the core namespace, then the user can simply write:
meta {import main::eval;};
   and then use eval as desired because this will not disturb any code that uses core::eval.

All software based on logic has its own idiosyncratic limitations, which are due to design considerations and implementation-related cost/benefit tradeoffs. But there are also other limits, which are inherent in logic itself. These limits are non-negotiable from an engineering point of view, in the sense that any tool that uses logic will be affected by these limits, since they follow from theorems of mathematical logic, including:
1. First-order predicate logic is recursively indecidable, i.e., no algorithm can decide whether a given formula is true or false. The exception is when all predicates are restricted to talk about properties of a single argument instead of general relations. The zero-argument case (a.k.a. propositional logic) is also an exception.
2. Propositional logic is decidable, but solving for truth values is an NP-complete problem.
3. Propositional logic consisting only of Horn clauses is solvable in polynomial time. However, Horn clauses can only represent a subset of all possible logic statements.

In explanation of the above, the first limit simply means that first-order predicate logic is so expressive that it can be used to state problems that are impossible to solve. A famous example is Alan Turing's halting problem: it is possible to write a logic formula that is true if a computer halts after executing a program, and false if the program loops forever. But no algorithm exists that can decide whether that formula is true or false. The second limit means that given a bunch of variable-free formulas, deciding whether a proposition is true or false is always possible in principle, but has a cost that as far as we know is exponential in the size of the problem (i.e. the total size of the facts and rules involved). The third limit says that even though variable-free Horn clauses can in fact be solved with reasonable efficiency; they are not as expressive as full first-order predicate logic.

Predicate logic is about propositions that make claims about “all” or “some”, e.g., “some cats are black” or “all Cretans are liars”. This later phrase is attributed to the Cretan philosopher Epimenides around 600 B.C. Since Epimenides was himself a Cretan, this is considered to be one of the earliest examples of a logical paradox. Formally, a predicate is a relation between n objects (the predicate arguments), where n can be 0, 1, 2, . . . and the predicate is true when the relation exists, otherwise it is false. A proposition in predicate logic normally contains quantified variables, which means variables that are introduced by saying “for all X . . . ” or “there exists an X such that . . . ” and then using the variable X in the proposition that follows.

First-order predicate logic (FOL) is predicate logic where the quantified variables can be used only as predicate arguments, never as predicates themselves. So in first-order logic you can express “all cats are black”, but not “all logical relations are true”. Predicate logic is extremely expressive, but predicate logic sentences are in general very hard to solve. It has been proven that there cannot exist any algorithm that is able to prove every true (tautological) proposition in FOL, unless all predicates are restricted to only one argument, i.e. where no multilateral relations are allowed.

Embodiments of the present rule engine use a subset of FOL that has an efficient proof procedure. The subset is known as “Horn clauses” and the proof procedure is known as “Robinson resolution”. Every program written for the present rule engine that returns an answer is guaranteed to have logical semantics, i.e., it can be proven from first principles that any answer or conclusion from any such program is always logically correct. There are however situations when no answer will be returned at all.

Operators used in embodiments of the present rule engine are listed in the table below, in descending order of precedence. Right-associative operators are shown as X•Y, while left-associative operators are shown as Y•X. Prefix operators are shown as either •X or •Y; both mean the same thing since no associativity is involved.

Right-associative operators are nested like this:
X•Y•Z=X•(Y•Z)
   and left-associative operators are nested like this:
Z•Y•X=(Z•Y)•X

### Table of Operators:

?X
X\hat{ }Y X**Y \
X.Y Y*X
Y/X Y//X
Y−X −X Y+X +X
X=Y X<Y X=<Y X<>Y X==Y X>=Y X>Y
not X
Y & X
Y | X
X is Y
X,Y
Y and X
Y or X
X−>Y Y<−X
X=>Y Y<=X
X:=Y :=Y
X:−Y :−Y
X-->Y -->Y

Embodiments of the present rule engine also contain a few built-in predicates. Such predicates are evaluated by the rule engine itself rather than by being proved by applying the resolution algorithm to facts and rules. Most built-ins use one or more arguments as input data, and optionally another argument that is unified with some computed output data. If the input data is an unbound variable, the built-in suspends until it gets a definite value. It is pretty obvious for most predicates which argument is input and which is output, so it is not explicitly stated here which one is which.

Arithmetic predicates can use different evaluators depending on the application. The default is an evaluator based on “java.math.BigDecimal”. This means that all numeric values are represented as arbitrary-precision decimal numbers of finite length. Rounding and extending the precision during calculations is done according to the rules of “java.math.BigDecimal”, unless otherwise noted.

These predicates evaluate arithmetic expressions:

| | |
|---|---|
| eval(X, Y) | Evaluates the arithmetic expression X and |
| | unifies the resulting value (a constant symbol) |
| | with Y. |
| X == Y | Evaluates the arithmetic expressions X and Y |
| | and returns true if the values are numerically |
| | equal. |
| X < Y | Evaluates the arithmetic expressions X and Y |
| | and returns true if the value of X is less than |
| | the value of Y. |
| X > Y | Evaluates the arithmetic expressions X and Y |
| | and returns true if the value of X is greater |
| | than the value of Y. |
| X <> Y | Evaluates the arithmetic expressions X and Y |
| | and returns true if the values are not |
| | numerically equal. |
| X >= Y | Evaluates the arithmetic expressions X and Y |
| | and returns true if the value of X is greater |
| | than or equal to the value of Y. |
| X =< Y | Evaluates the arithmetic expressions X and Y |
| | and returns true if the value of X is less than |
| | or equal to the value of Y. |

Arithmetic expressions are just Herbrand terms with a special interpretation. A numerical constant is interpreted as the corresponding numeric value. Other terms are interpreted according to the following tables.

### Symbolic Constants:

Pi 3.141592653589793, which is the value of # to 16 digits accuracy.
E 2.718281828459045, which is the value of e to 16 digits accuracy.

Unary functions:

| | |
|---|---|
| +X | Identity operation, has the same value as X. |
| −X | Sign change. |
| abs(X) | Absolute value (non-negative). |
| acos(X) | Inverse cosine. |
| asin(X) | Inverse sine. |
| atan(X) | Inverse tangent. |
| ceil(X) | The smallest integer not less than X. |
| cos(X) | Cosine. |
| exp(X) | Exponential with base e. |
| floor(X) | The largest integer not greater than X. |
| log(X) | Logarithm with base e. |
| round(X) | The integer closest to X. Uses the |
| | java.math.BigDecimal.ROUND_HALF_EVEN |
| sin(X) | Sine. |
| sqrt(X) | Square root. |
| tan(X) | Tangent. |

Binary functions:

| | |
|---|---|
| X + Y | Addition. |
| X − Y | Subtraction. |
| X * Y | Multiplication. |
| X/Y | Division. The quotient is rounded to the |
| | number of decimals of Xplus the number of |
| | decimals in Y. |
| X//Y | Integer division. The result is the largest |
| | integer not greater than the quotient. |
| mod(X, Y) | Remainder. Defined by: X − (X//Y) * Y. |
| X**Y | Exponentiation. The value of 0**0is 1. |
| atan2(X, Y) | Inverse tangent, 4-quadrant version. |
| ceil(X, Y) | Rounds Xupwards to Ydecimal places. |
| floor(X, Y) | Rounds Xdownwards to Ydecimal places. |
| max(X, Y) | The largest of Xand Y. |
| min(X, Y) | The smallest of Xand Y. |
| round(X, Y) | Rounds X to Y decimal places, using the |
| | java.math.BigDecimal.ROUND_HALF_EVEN |
| | rounding rule. Note: One special use |
| | of this function is to increase the number |
| | of decimals of a number. For example, |
| | round(1, 42) produces a number with the |
| | value 1 and a precision of 42 decimals. |

Embodiments of the present rule engine have syntactic sugar for writing terms that contain external parameters. If a variable begins with a $ sign it is interpreted as an external parameter, which is accessed via the built-in predicate sys::param. For example:
if expiration_time(T) and T<5TIME then expired;
   The above is equivalent to:
if expiration_time(T) and sys::param(“TIME”,X) and T<X then expired;
   where X is a variable that does not occur elsewhere.
sys::param(X,Y) Unifies Y with the value of the external parameter X.

The exact semantics of sys::param varies depending on the application. In the process engine for example, there is an external parameter generated by the timer named TIME which has the value of java.lang.System.getCurrentTimeMillis( ) at the point in time when a process state-transition is initiated. In the standalone rule-engine on the other hand, sys::param is simply defined as:
sys::param(X,Y):=parameter(X,Y);
   where parameter(X,Y) is defined by user rules.

The following is a list of builtins that test or extract symbolic information about terms, and construct new terms from such information.

| | |
|---|---|
| atomic(X) | True if X is an atomic symbol, i.e. a non- |
| | composite term. |
| number(X) | True if X is a numeric symbol. |
| atom_length(X, Y) | Y is unified with the length of the symbol |
| atom_concat(X, Y, Z) | Z is unified with the symbol whose name |
| | is the concatenation of the names of the |
| | symbols X and Y. |
| sub_atom(X, Y, Z) | Z is unified with the symbol whose name |
| | consists of the characters from position Y in |
| | the name string of the symbol X. |
| sub_atom(X, Y, L, Z) | Similar to sub_atom(X, Y, Z), but only the |
| | first L characters of the substring are used. |
| compose_term(X, Y, Z) | Z is unified with the term whose functor |
| | name is Xand whose argument list is Y. |
| decompose_term(X, Y, Z) | Y is unified with the functor name of the |
| | term X, and Z is unified with its argument |
| | list. |

A simple reflective “call” primitive has been added to embodiments of the present rule engine for practical reasons. In theory this is a second-order extension to first-order logic, but in practice it is just a limited tool for reflective programming. It is only for convenience—it does not provide any functionality that cannot be obtained in a straightforward but more elaborate way using regular first-order constructs. The main purpose is to provide a simple way to express negation. Another use is to allow for callbacks into the runtime symbol table from a rule that was defined elsewhere.

| | |
|---|---|
| call(X) | Reflective call. Waits until X gets bound to a |
| | term, and then substitutes call(X) for the |
| | predicate that has the same name as the |
| | function symbol of the term, and that has |
| | the same arguments. The predicate name |
| | space used is fixed when a query is initiated. |
| | Normally it is the same name space as for |
| | the query, but this can be changed via the |
| | Java API. |
| call(X, Y) | Reflective call. Waits until X gets bound to |
| | a term and Y gets bound to a list of definite |
| | length, and then substitutes call(X, Y) for |
| | the predicate that has the same name as |
| | the function symbol of the term X and that |
| | has as its arguments the arguments of X |
| | followed by the elements of the list Y. The |
| | predicate name space used is fixed when a |
| | query is initiated. Normally it is the same |
| | name space as for the query, but this can be |
| | changed via the Java API. |
| and(X, Y) | Equivalent to: if true then call(X) and |
| | call(Y); |
| not(X) | Equivalent to: if call(X) then false else |
| | true; |
| or(X, Y) | Equivalent to: not(not(X) and not(Y)); |

The two-argument call(X,Y) is a sort of “uncurrying” version of the single-argument call(X). For example, call(p(A,B,C),[X,Y,Z]) is equivalent to call(p(A,B,C,X,Y,Z)).

As can be seen from its definition, the predicate not makes a reflective call from within a guard. This means that e.g., not(hasFeathers(X)) can never produce solutions like X=garfield or X=fido. Instead it will suspend until X gets a value that can be tested.

As previously noted, negations are to be understood with a closed-world assumption. This assumption means that a predicate is considered false if all of its clauses fail to solve it. There can be no additional clauses outside of the current rule-set that might solve the predicate.

The built-in definition of or is just an application of De Morgan's theorem, using the built-in limited version of not. This is useful in the context of simple tests, but it won't handle disjunction that introduces full-blown non-determinism. A disjunction predicate that handles the general case could be defined like this:
or(X,Y):=
   fork(Z) and orChoice(Z,X,Y);
orChoice(Z,X,Y):=
   if Z=0 then call(X)
   else call(Y);
      It is however not recommended that such a definition be used routinely for all cases where disjunction needs to be expressed. The reason is that non-determinism is both expensive and unpredictable, so it should be made explicit in all circumstances where it is used.

Syntactic sugar for existential quantification is for convenience, i.e., one could do entirely without this by introducing extra “helper” clauses whenever existential quantification is needed. Note that there is no syntax for universal quantification (V). Universal quantification is implicit at the outermost level of a Horn clause, for all of the variables contained inside it. Since the antecedent part of a Horn clause is formally contained within a negative formula, this universal quantification is completely equivalent to existential quantification for variables that are present only in the antecedent.
Ŷp(X,Y,Z) Like p(X,Y,Z) but with Y existentially quantified. Technically p(X,Y,Z) is handled via a reflective call, except that it is not allowed to write e.g., YAT where T is a variable bound to a term.

This would not make sense since the scope of the existentially quantified variable Y is lexical.

A typical use of this clause is when there is a need to express something like: “if there is a dancer who does not have a partner, then . . . ” One would naively expect something like this to work for the conditional part:
if dancer(X) and not partners(X,Y) then . . . ;
   However, the present rule engine interprets this to mean “if there is a dancer X and a thing Y such that X and Y are partners, then . . . ” which is something entirely different. And even if this was the intended meaning, the rule engine could never prove the condition true since its resolution algorithm would be required to produce at least one example of some “thing” Y for which the condition is true, and this is not possible.

The problem is fixed by using existential quantification:
if dancer(X) and not Ŷpartners(X,Y) then . . . ;
   Here the meaning is changed to “if there is a dancer X, and it is not the case that there is a thing Y such that X and Y are partners, then . . . ”

This is semantically equivalent to the following solution where an extra “helper” predicate is introduced:
has_a_partner(X):=partners(X,Y);
if dancer(X) and not has_a_partner(X) then . . . ;
   In this particular example the helper predicate has intuitive semantics, but that is not always the case.

In embodiments, the fundamental time coordinate is Java's “timeMillis”, which is approximately the number of milliseconds since 00:00:00 UTC on Jan. 1, 1970. It is approximate for two reasons: the computer's clock may not be perfectly synchronized with UTC, and UTC uses leap seconds which are not accounted for in the time coordinate. As of 2009, exactly 24 leap seconds have been inserted since 1970, so the true number of elapsed milliseconds is 24000 higher than the nominal time coordinate. Atomic time (TAI) can be derived by offsetting the UTC date with the extra leap seconds, and then adding 10 more to account for the initial offset between UTC and TAI.

| | |
|---|---|
| sys::timemillis_date(Millis,Timezone, Date) | Date is unified with the 9-argument term |
| | sys::date(Year,Month,Day,Hour,Minute,Second, |
| | Millisecond,Zone_offset,DST_offset) |
| | which is calculated from Millis and Timezone. |
| sys::date_timemillis(Date,Millis) | Millis is unified with the time coordinate that |
| | corresponds to the 9-argument term |
| | sys::date(Year,Month,Day,Hour,Minute,Second, |
| | Millisecond,Zone_offset,DST_offset). |
| sys::timemillis_misc(Millis,Timezone, | Day_of_week,Day_of_year, and |
| | ISO_8601_week_{—} |
| Day_of_week,Day_of_year, | number are unified with values |
| ISO_8601_week_number) | calculated from Millis and Timezone |

The arguments of the sys::date compound term have the same values as the following Java fields:
java.util.Calendar.YEAR
java.util.Calendar.MONTH
java.util.Calendar.DAY_OF_MONTH
java.util.Calendar.HOUR_OF_DAY
java.util.Calendar.MINUTE
java.util.Calendar.SECOND
java.util.Calendar.MILLISECOND
java.util.Calendar.ZONE_OFFSET
java.util.Calendar.DST_OFFSET
   Note that Zone_offset and DST_offset are in milliseconds, and that Year is the 4-digit year. The rest of the arguments are exactly like their POSIX equivalents. The Timezone argument should be an exact match to one of the time zone IDs of the java.util.TimeZoneclass, e.g. “Europe/Zurich”.
   Day_of_week is in the range 1-7 where 1 is Sunday.

### Day_of_year is 1 for January 1.

ISO_{—}8601_week_number is the week number as defined by ISO 8601, where week 1 is the week that contains January 4, and the week number changes between Sunday and Monday.

These could have been defined within the language, but are provided for convenience.

| | |
|---|---|
| True | Equivalent to a single empty clause. |
| False | Equivalent to a predicate with an empty |
| | clause list |
| fork(X) | Non-deterministic predicate that is true for |
| | both X = 0 and X = 1, and produces both |
| | solutions if needed. |

The general syntax for a meta statement is:
meta {D1; D2; . . . ; Dn;};
   where the Dᵢ are declarations that affect the interpretation of the rules and facts that follow later in the file. The following declarations are available, presented as examples:

| | |
|---|---|
| import foo::bar | Declares that the symbol foo::bar can from |
| | here on be referenced as just bar, without |
| | any namespace qualifier. |
| namespace foo | All symbols from here on will be in the |
| | namespace foo, except for the standard |
| | core symbols that are implicitly imported |
| | into all namespaces. |
| use “file:///opt/rules/foo” | Use rules from the resource specified by the |
| | URL file:///opt/rules/foo. |
| argnames f(a,b,c) | Declares keyword-argument syntactic sugar |
| | for the functor f. From here on f[c = Z, a = X] |
| | is syntactically equivalent to f(X, _, Z). |
| open_world_assumption p/1,q/0,r/3 | Declares the specified predicates to fall |
| | under the open-world assumption. See |
| | the section called “The closed-world |
| | assumption and when it's needed”. |

Implementation of an embodiment of a system for operating the present rule engine can be accomplished in a number of different manners. The main functional components for implementation of such a system may include a JAVA EE server, which contains the rule engine, a file repository, which serves the rule definitions and configuration files, a SQL database, an optional SSL reverse proxy, and a load balancer. In a development environment, no load balancer was used and all remaining components of the system were run on the same server, but the different components have been moved to separate machines and operated successfully. It is to be noted that the file repository is not necessarily a homogenous service. Different types of files could be served from different sources, e.g., mounted file systems, SQL databases, web services (WebDAV or plain HTTP), DROPBOX, etc. For purposes of the present disclosure, however, the file server will be assumed to be an SQL-based web server.

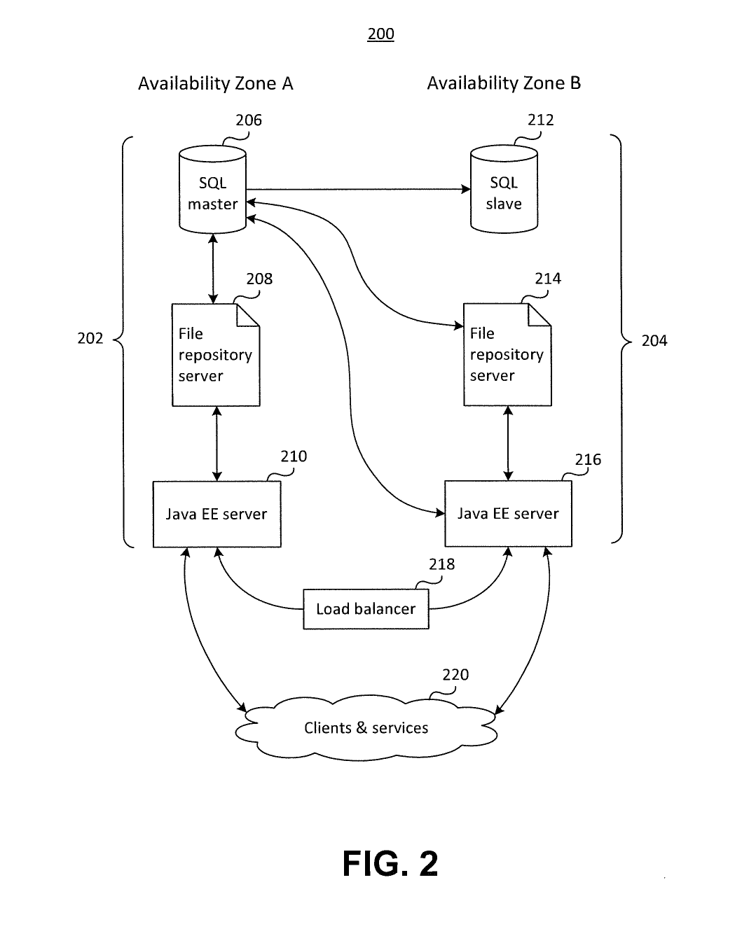

FIGS. 2, 3, 4, 5A, 5B and 5C illustrate different configurations of these functional components. FIG. 2 illustrates a basic high-availability architecture 200, which availability zone A, 202, and availability zone B, 204. Zone A 202 includes an SQL master database 206, file repository server 208 and JAVA EE server 210, while zone B 204 includes a SQL slave database 212, file repository 214, and JAVA EE server 216. The load balancer 218 distributes client and services demand 220 between the two zones as appropriate.

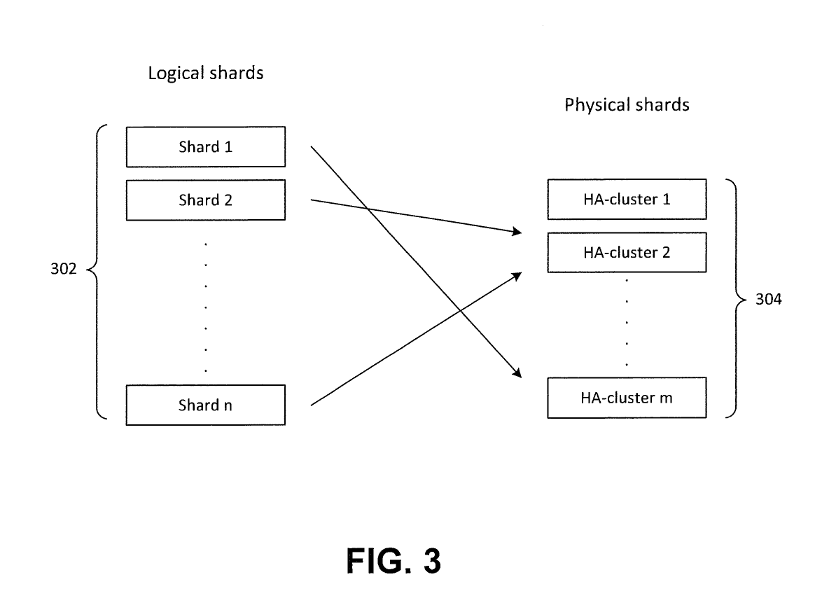

FIG. 3 illustrates scaling by sharding, where each of the logic shards 302 corresponds to a subset of the total set of processes. For example, logical shard k could be all processes for which PID=k mode n, where PID is the process ID number. Each logical shard is mapped to a physical shard 304 in a similar way, although a different algorithm may have to be used to insure that m of physical shard 304 can grow without changing earlier logical-physical mappings. The routing to a physical shard from a given PID must be done through some shared resource, like load balancer 218.

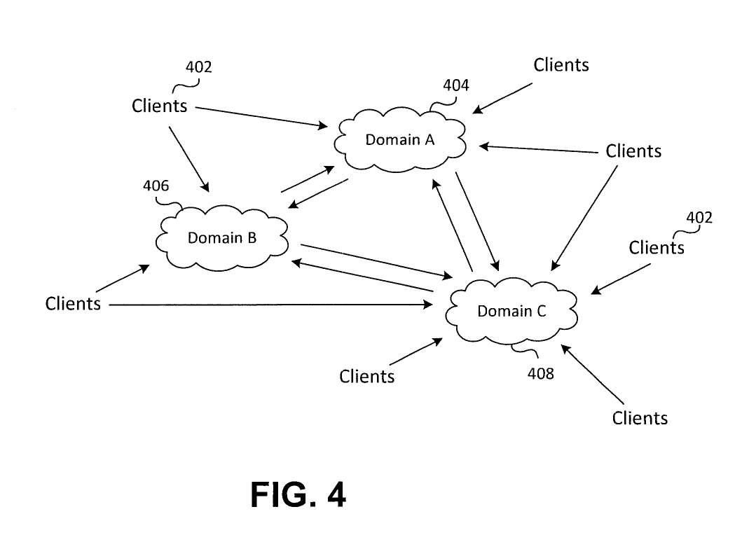

FIG. 4 illustrates what is called scaling by fragmentation, where “fragmentation” is intended to refer to the type of scaling accomplished by the World Wide Web. In this implementation, the only shared resource is the root name server DNS infrastructure, as with the Web. Each domain serving clients 402, such as Domain A 404, Domain B 406, Domain C 408, etc., corresponds to either a sharded cluster as illustrated in FIG. 3, a single high availability cluster as illustrated in FIG. 2, some other kind of cluster, or a single server. Each domain is completely autonomous and there are no points of contention except for the unavoidable ones in the underlying Internet routing and DNS resolutions systems. Adapting an application utilizing an embodiment of the present rule engine to the architecture of FIG. 4 simply requires generalizing the process ID numbers to a domain plus a local PID.

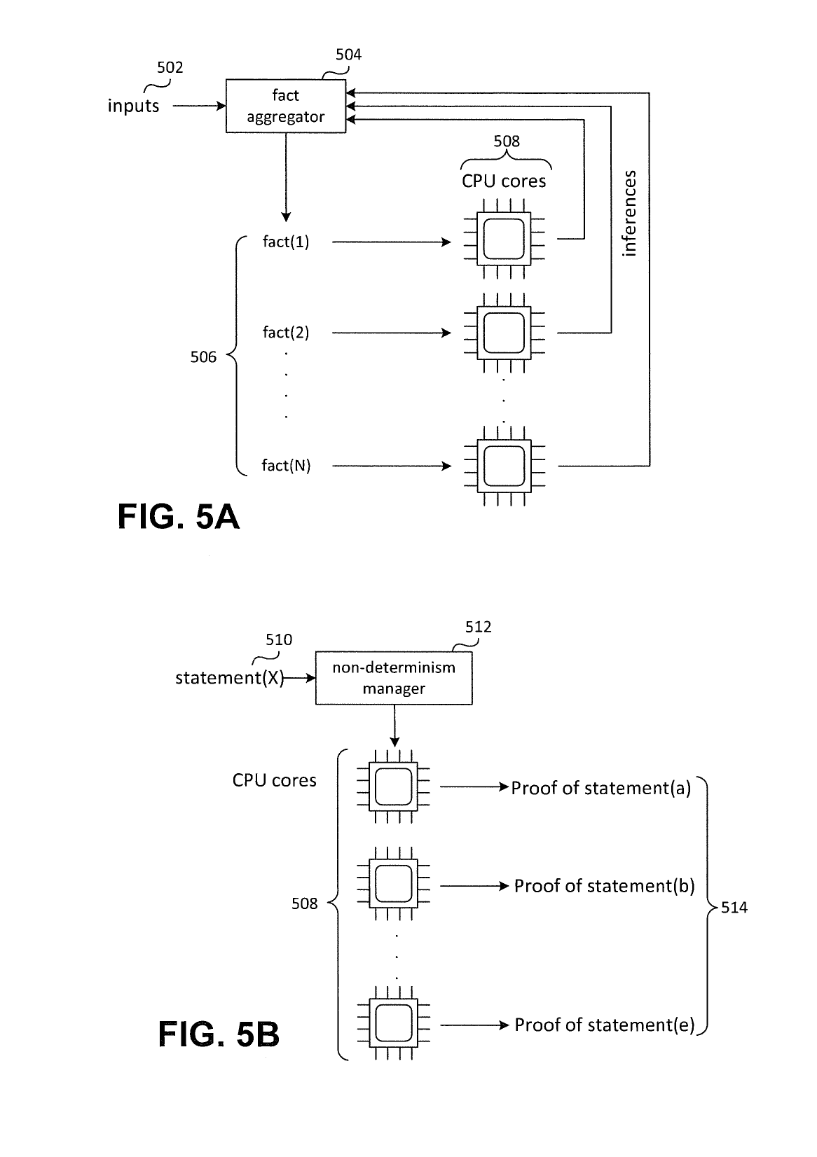

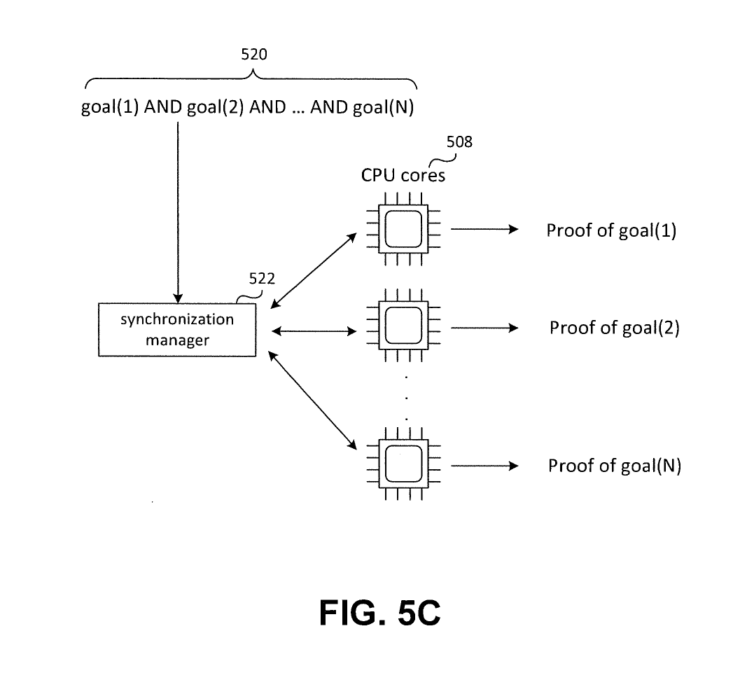

FIGS. 5A, 5B and 5C illustrate computation scaling in three different configurations. FIG. 5A illustrates parallel forward-chaining, where input facts 502 are combined by fact aggregator 504 and the combined facts 506 are distributed to parallel CPU cores 508, which makes inferences from the fact combinations 506 and takes actions based on those inferences. In embodiments of the present rule engine, these actions are idempotent and independent of the order in which inferences are made, which is a consequence of the logical semantics of the rules of the rule engine. Since the ordering of the inferences is irrelevant to the final result, parallel execution is a possibility. Any parallel speedup factor for an application will, of course, depend on the structure of the rule logic in that application.

OR-parallelism in backward-chaining is illustrated in FIG. 5B, backward-chaining takes a statement 510, usually one containing variables, and finds one or more solutions in terms of variable bindings that satisfy the statement 510. The non-determinism manager 512, which distributes the statement to the CPU cores 508, generalizes the concept of backtracking found in PROLOG and other sequential programming languages. In embodiments of the present rule engine, such solutions are always consistent with a logical proof of the statement 514, which is a consequence of the logical semantics of the rules of the rule engine. Whenever backward-chaining explores multiple alternative solutions, the order of execution of these alternatives is irrelevant, since the solutions that satisfy one operand of an “OR” statement are completely independent of any proof of the other operand. This makes parallel computation of backward-chaining alternatives a possibility. Any parallel speedup factor for an application will of course depend on the structure of the rule logic in that application.

FIG. 5C illustrates AND-parallelism in backward-chaining. Whenever a backward-chaining goal (the statement to prove) consists of a conjunction that contains two subgoals 520, the proof of these two subgoals can be executed concurrently as long as partial solutions in terms of variable bindings for each subgoal are consistent with each other. True parallel execution can be achieved when the subgoals are independent of each other. When the subgoals are not independent, the dependencies are manifested through the sharing of logical variables. These shared logical variables can be used to synchronize (e.g., through synchronization manager 522) concurrent execution of the subgoal proofs while leveraging parallel execution whenever possible. As usual, any speedup factor for an application depends on the structure of the rule logic.

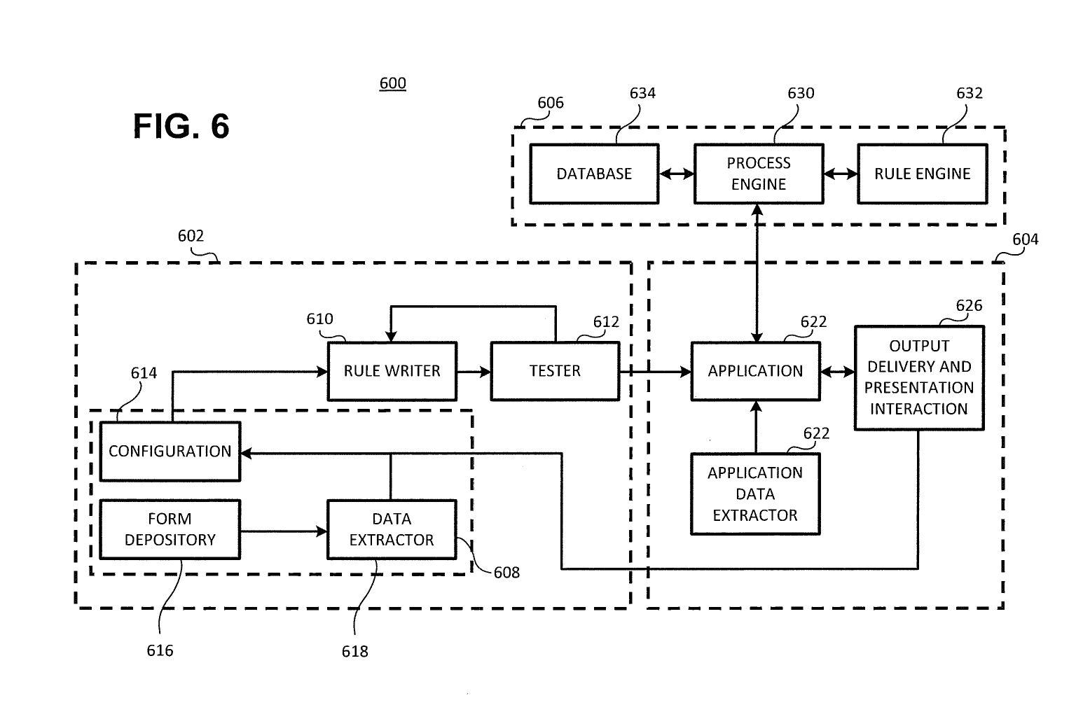

While extremely powerful, the logical programming language and syntax of embodiments of the present rule engine and the logical construct of a process engine, generally regardless of the type of engines utilized, are complicated and difficult for many people to readily understand. While some people can learn how to use a rule engine and process engine to write the lines of code necessary to effectively utilize the power of the rule engine and process engine to create useful and adaptable application programs, doing so takes considerable time and tends to generate highly varied results. Rather than attempt to teach most users the language and syntax of the rule engine and the most effective manner of taking advantage of the process engine, an embodiment, illustrated in FIG. 6, utilizes a rule writer to convert the indicated desires of users into application programs that operate in conjunction with the rule engine and process engine.

The rule writer may make it possible to leverage standard rule templates generated by the rule writer with pre-defined process states, actions, input types and output types that are relevant for specific end use applications, to enhance the usefulness and processing of data. The type of applications may include business workflows for colleague collaboration, a mobile personal assistance application, and other applications as further described below.

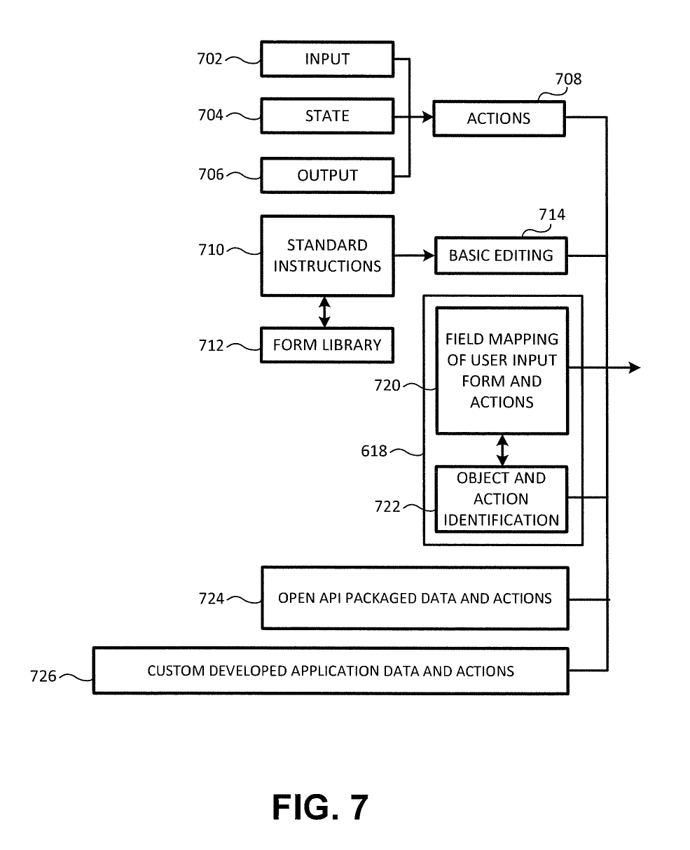

To further understand the overall logic application system of the embodiment, reference is made to FIG. 6. The overall system 600 may include at least of three primary sections, the input section 602, the application section 604 and the processing section 606, each of which may include of a number of elements, which are more fully described below. Input section 602 may include at least of a configuration section 608, the rule writer 610 and the tester 612. The configuration section 608, which is further described with reference to FIG. 7, may include at least the configurator 614, a form depository 616 and a data extractor 618. The application section 604 may include at least an application 622, an application data extractor 624, and an output delivery and presentation interface 626. The processing section 606 may include at least of a process engine 630, a rule engine 632 and a database 634.

The configurator 614 may receive input data from users in a variety of different ways, as illustrated in FIG. 7. The configurator 614 then uses the input data to instruct the rule writer 610 to produce the code core to an application that may achieve what the user desires. The manner and method of instructing the rule writer 610 can vary greatly. Five different options by which data and directions may be formatted so as to instruct the rule writer 610 are shown in FIG. 7, but these options are just examples and the embodiments should not be limited to just the examples shown.

Option one, which includes the instructions for writing one or more rules in the form of input 702, state 704, output 706 and actions 708, is intended for users that have a very clear understanding of what they want an application written using the rule engine and process engine to perform. Under option one, the user may be required to be able to identify a number of different process states 704 that they can anticipate the application entering during its operation, the one or more inputs 702 that may be received at each of those states 704, the one or more expected outputs 706 of each state 702 and the one or more actions 708 to be performed at each state 702. Option one may also require that the user be able to identify some logical aspect of each of the actions 708, such as forward-chaining or backward-chaining or a combination of both as described above.

For example, if an application related to the processing of information about a newly hired employee, a first state might involve the evaluation of data received as an input, such as an employee name, and action to determine if all of the required data regarding the name had been received, such as a family name, a given name and either a middle name or a null entry indicating that the employee has no middle name. If all of the required data had been received by the first state, then an action to be performed may involve approving the name and forwarding that name to one or more other states that perform additional actions, such as creating a record for the employee in a human resources system, as long as one or more other necessary inputs are also received, etc. Likewise, if the name had not been approved, the action taken may involve returning the name to the input source for correction.

As noted, a single state may have multiple inputs, multiple outputs and multiple actions associated with that state. Within option one, a user may be capable of defining, at least to some degree, the nature of the action to be performed in such a way as to make it easier for the rule writer to craft an appropriate rule or rules for the specified state. For example, if the user is able to recognize that the input is a fact that can be used in a forward-chaining process, the user could identify the action in this manner. Likewise, if the user is able to recognize that the input is a query that can be used in a backward-chaining process, the user could identify the action in that manner. Some actions lend themselves to both forward-chaining and backward-chaining processes, which a user may not recognize, so the rule writer 110 includes the ability to assess the user input instructions and develop appropriately efficient rules based on those input instructions.

Option two is designed for the user that does not want to identify all of the necessary instructions, or is not capable of doing so, and is willing to make some compromises regarding what the user would prefer in favor of standardized instructions 710 that do most of what a user might want. The standard instructions may be incorporated into a form that is populated with data, where each entry corresponds to a standard action that may be taken based on that data. Returning to the new employee processing example discussed above, with regard to option one, a form may already exist in a form library 712 that includes most if not all of the instructions that the user would want to use to process its own employees. If the user is completely willing to compromise on what the user wants from the form, the user could accept the standard form exactly as it is. On the other hand, if there were some instructions that the user wanted to delete, because those instructions were not needed, or the user wanted to change the name or type of data input at certain locations on the form, the user could use the basic editing element 714 to make modest changes to the standard form, such as those changes noted above.

Option three is designed to be similar to option two except in this case the form to be utilized is a user generated form that has been dropped (electronically) by the user into the form depository 616 illustrated in FIG. 6, where it is processed by the data extractor 618, illustrated in both FIGS. 6 and 7. To process the data in the user created form, the data extractor 618 may determine and map the location of each object or field on the user form 720, including graphic objects, such as radio buttons, lines, text boxes, etc., and other information that may be associated with those graphic objects, such as numbers, text, colors, etc., into a format required by the system to properly develop the instructions for the rule writer 610. The user would then be required to identify 722 on the formatted form what the data, i.e., the different graphic objects and text, on the form represents and the actions to be performed based on such data.

While some of the first forms to be produced for receiving instructions for the system 600 may be limited to forms developed by the operator of the system 600, over time, users will develop certain forms (Option four) that they may reuse themselves or be willing to share with other parties, either for free in an open source type environment 724 or in exchange for some small fee in a shareware type of environment. Designed forms could also be purchased in the same manner as applications for mobile devices, where developers are encouraged to develop unique, custom forms 726 (Option five) that are sold for modest prices, ideally, and are rewarded through a volume of purchases.

Other embodiments for inputting data to the rule writer are obviously possible, so the few embodiments described herein are not intended to be and are not the limit of all possible embodiments for having rules written for people without rule writing skills. For example, rules could be written in plain English and rule code could be translated automatically from the plain English text to rule code. In an embodiment, a translator of Domain-Specific Languages (DSL) for rule execution is utilized. DSL includes any type of coding scheme used for controlling a computer, where this coding scheme is not a general-purpose programming language. For the purpose of generating rule code for the rule engine from a rule-authoring system (using another language, such as English text), a DSL may be defined by a custom XML file that has the following general format:

<?xml version=”1.0” encoding=”UTF-8”?>
<dsl>

<symbol>...</symbol>
<symbol>...</symbol>
.
.
.
<symbol>...</symbol>
<macro>...</ macro >
<macro>...</ macro >
.
.
.
<macro>...</ macro >

</dsl>

The above format consists of a sequence of <symbol> elements followed by a sequence of <macro> elements. Each symbol element consists of a word or phrase together with an attribute that specifies the symbol's class. For example:
<symbol class=“color”>green</symbol>
<symbol class=“color”>red</symbol>
<symbol class=“device”>light</symbol>
<symbol class=“vehicle”>car</symbol>
<symbol class=“state”>moving</symbol>
<symbol class=“state”>still</symbol>

Each macro element consists of a <template> element and a <rules> element. The relationship between these templates and rules is best explained through an example, as follows:

<macro>

<template>

if the {device} is {color}, then the {vehicle} must be {state}.

</template>
<rules>

device(color), vehicle(Index,X), not X=state

=> fail(Index,vehicle,state);

</rules>

</macro>

To illustrate how the above-described macro translator would work on a couple of rules expressed in plain English, consider the following sentences:
If the light is green, then the car must be moving.
If the light is red, then the car must be still.
   The translated result would be the following two rules:
light(green), car(Index,X), not X=moving=>fail(Index, car,moving);
light(red), care(Index,X), not X=still=>fail(Index,car,still);

Since the verb “must be” in the English text (a macro template) is logically a deontic operator, it cannot be expressed directly in standard first-order logic. Instead, the macro translates the verb into a negative condition in the rule antecedent that implies a “fail” consequent. The presence of such an inferred “fail” means that the corresponding compliance rule has been violated. It should also be noted that the rule engine code contains two logical variables, Index and X, which have no direct counterparts in the macro template. Index is in the case actually part of a hidden data model that assigns an index to each vehicle. This lets the rule engine rules handle multiple cars at the same time. The index is repeated in the “fail” consequent so it is possible to identify exactly which car or cars violated a rule. X is just a placeholder for the vehicle state (e.g., “moving” or “still”), which in this case needs its own variable in order for the negation to work as intended. If there was no index variable, it would be possible to simplify
car(X), not X=moving
   into
not car(moving)
   It will not work, however, if the rule was written as “not car(Index,moving)” unless Index is either bound outside the negation or existentially quantified inside it. The latter would, however, change the meaning into saying that at least one care must be moving if the light is green.

A special syntax allows more than one instance of a symbol class in the same macro template. For example:

<symbol class=”name”>Oprah</symbol>
<symbol class=”property”>rich</symbol>
<symbol class=”property”>famous</symbol>
<symbol class=”type”>celebrity</symbol>
<macro>

<template>

if {name} is {property:a} and {property:b}, she is a {type}.

</template>
<rules>

a(name), b(name) => type(name);

</rules>

</macro>

Applying this macro to:
If Oprah is rich and famous, she is a celebrity.
   will produce this rule:
rich(“Oprah”), famous(“Oprah”)=>celebrity(“Oprah”);

This rule is a bit weak since it is hardwired for Oprah, instead of containing variables that could make it applicable to anyone, but it conveys the basic idea of the translation. Logic variables are generated as follows:

<macro>

<template>

if {X1} is the {relations:a} of {X2},

and if {X3} is the {relation:b} of {X4},
then {X5} is the {relation:c} of {X6}.

</template>
<rules>

a(X1,X2), b(X3,X4) => c(X5,X6);

</rules>

</macro>

By convention, template parameters that start with an uppercase letter will be treated as logic variables in rule generation. In this example, “X1”-“X6” will be treated as variables.

Applying the above macro to some English text as follows:
If the first person is the parent of the second person,
and the first person is the parent of the third person,
then the second person is the sibling of the third person.
   will produce the following rule:
parent(A,B), parent(A,C)=>sibling(B,C);
   In this case, both “X1” and “X3” in the macro are mapped to the “the first person”, but in the generated rule, both “X1” and “X3” are replaced by a generated variable name “A”. The remaining variables are handled in the same way. New names are generated for the logic variables since there are restrictions on their syntax in the rule engine, so it is not possible to use “the first person” directly as the variable name. Since the scope of a logical variable is limited to a single rule clause, there is no need to keep the names of generated variables unique, except within each rule.

The same macro can be used for a different rule, such as:
If the first person is the child of the second person,
and the second person is the child of the third person,
then the third person is the grandparent of the first person.
   The macro will now produce:
child(A,B), child(B,C)=>grandparent(C,A);
   Lists, or simple enumerations, are not uncommon in various types of compliance rules. Such lists can be mapped to tables of rule engine facts or rules, for example:

<macro>

<template>

When the color space is {colorspace},
The primary colors are {@colorlist}.

</template>
<rules>

space(colorspace), colorspace(C) => primary(C);
<iterate var=”item” list=”@colorlist”>

colorspace(item)

</iterate>

</rules>

</macro>

Applying this macro to these two input:
When the color space is RGB, the primary colors are red, green, and blue.
When the color space is CMYK, the primary colors are cyan, magenta, yellow, or black.
   will produce the following rule engine code:
space(“RGB”), “RGB”(C)=>primary(C);
“RGB”(red);
“RGB”(green);
“RGB”(blue);
space(“CMYK”), “CMYK”(C)=>primary(C);
“CMYK”(cyan);
“CMYK”(magenta);
“CMYK”(yellow);
“CMYK”(black);
   Note that the enumeration in the template can optionally use either “and” or “or” before the last element. This is only a matter of style; the lists are handled in exactly the same way by the rule generator.

From an implementation perspective, the XML files that contain the symbol and macro definitions may need to be hand-coded by human programmers, at least for now. These XML files may then be combined as “building blocks” that together define a domain-specific language. This may be done in a GUI where different building blocks are enabled for inclusion. The same GUI may then let the rule author compose rules in the domain-specific language by selecting and coming templates and symbols from various menus and text-input fields. The resulting DSL rules are then processed as input by the rule generator to produce executable rule engine rules as the output.

The processing proceeds by taking one input DSL rule at a time and matching it against the template of each macro until a match is made. Matched template parameters are then substituted in the rules section of the macro according to the principles described above. If at least one successful match is found, the rules corresponding to the last match found are added to the output. Optionally, a warning is also presented if more than one successful match was found. If no successful match is found at all, an error message is presented for that DSL rule, and the translation is aborted. The matching processing uses a conventional backtracking algorithm that searches for the template as a pattern in the input, while keeping track of the resulting bindings of the template parameters.

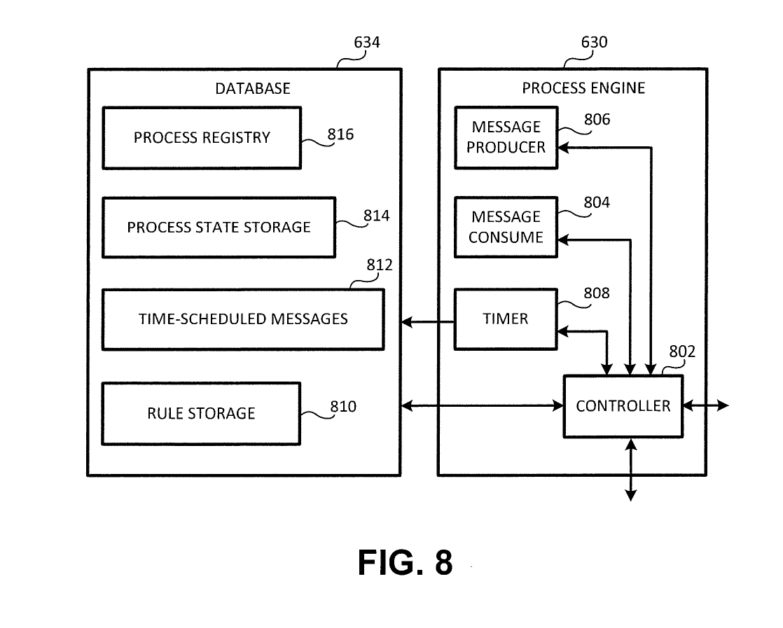

FIG. 8 further illustrates the database 634 and process engine 630 of FIG. 6. The controller 802 regulates interaction between the application 622 and the processing section 606, as well as the database 634 and the rule engine 632. The controller further handles the processing of messages being sent to and from the processing section 606 via message consumer 804 and message producer 806, and the timing of operations within the processing section 606 through timer 808. The database 634 includes a number of separate sections of data, including rule storage 810 for the rules to be implemented by the rule engine, time-scheduled messages 812, process state storage 814 and process registry 816.

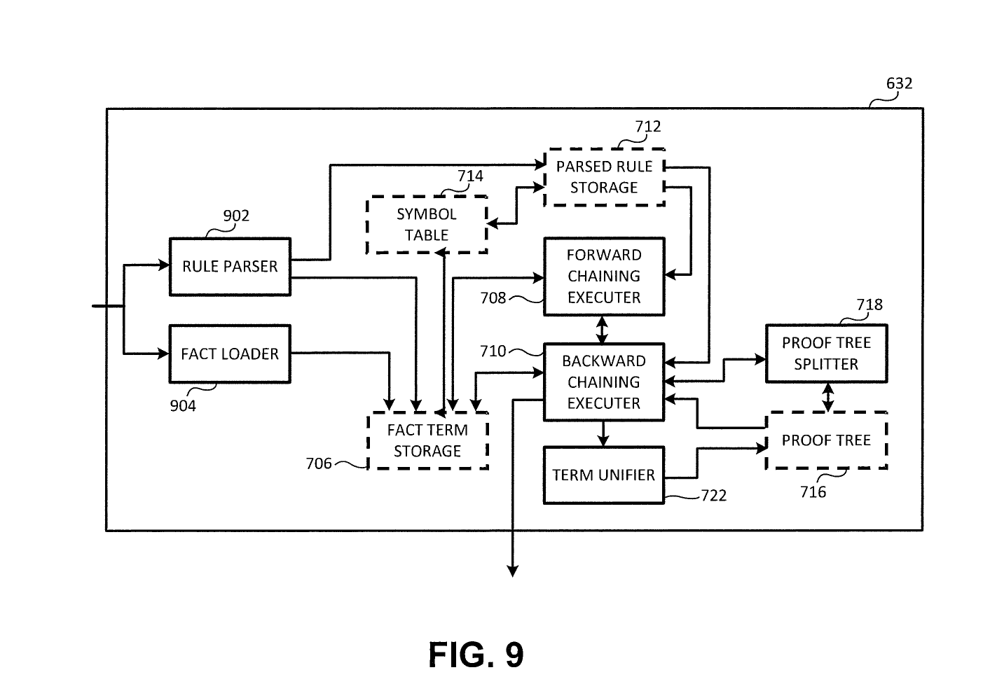

FIG. 9 illustrates details of an implemented embodiment of the rule engine 632, where functional sections are illustrated by a solid line around the stated function and storage areas (stored in the database 634) are illustrated by dashed lines. Rules and facts are input to the rule engine 632 and routed to either rule parser 902, for the rules, and fact loader 904, for the facts. Parsed rules are then stored in the fact term storage 706 for use by the forward-chaining executor 708 or the backward-chaining executor 710, or both when so combined. Parsed rules are likewise stored in the parsed rule storage 712 for input to forward-chaining executor 708 or backward-chaining executor 710. Symbols are supplied by the symbol table 714. As rules and facts are executed by the backward-chaining executor 710, proofs or suspended proofs are stored in the proof tree 716 and proof tree splitter 720, and as separated rules are proofed, terms are reunited by the term unifier 722. The result of the rule engine's logical analysis is output from the backward-chaining executor 710.

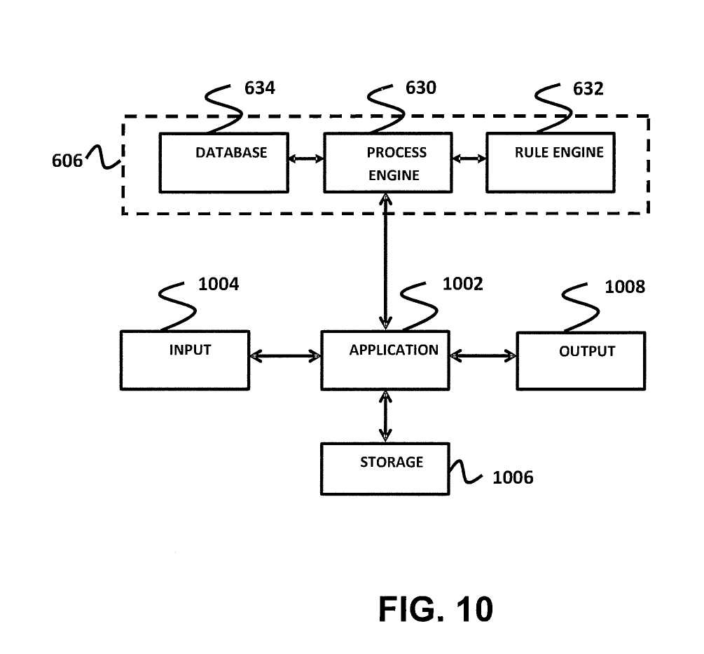

Although some examples of applications are referenced above, there is theoretically no limit to the manner in which the rule engine could be implemented in an application environment. As illustrated in FIG. 10, any application 1002, having input 1004 (which could be one or more of any known data entry form, such as keyboard, graphical user interface, etc.), storage 1006 (non-transitory) and output 1008 (also of any form) may be configured in an embodiment to communicate with the processing section 606 of FIG. 6, and as described in reference thereto. As previously described, the application 1002, input 1004, storage 1006, output 1008, and the various elements of the processing section 606, may be physically co-located, each any every element could be physically located in a different place, or various combinations could be made possible. For example, application 1002 could be operated on a mobile device that receives input from a user through the mobile device as well as other sources, such as through cellular, WIFI and other networks, infrared scans, etc., stores information on the mobile device and on cloud storage, communicates with the processing section 606 through the cloud, where those logical elements are operated on some remotely located server, and outputs data to the mobile device or some other device through a network.

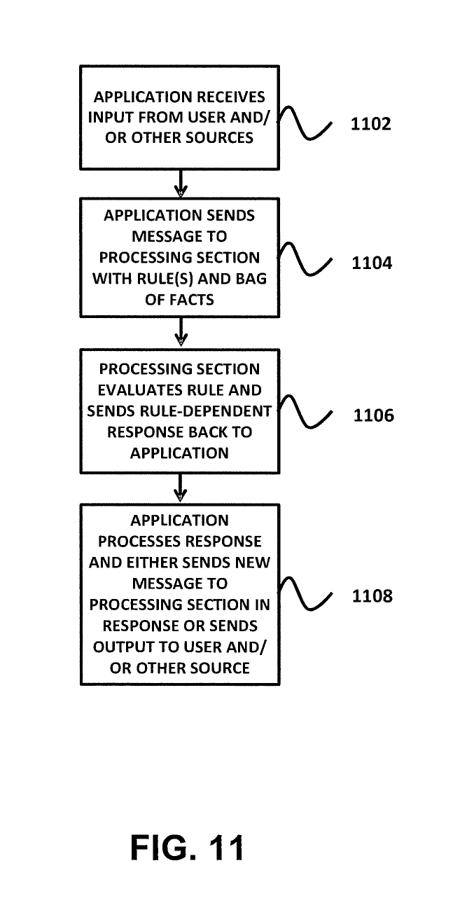

FIG. 11 illustrates an embodiment of basic communication between the application 1002 and the processing section 606. In step 1102, the application 1002 receives input from a user and/or other sources, which may be in the form of facts or rules to be implemented by the application 1002. In step 1104, the application 1002 then sends a message, or more than one message, to the processing section 606 with the rule(s), if any, and the bag of facts applicable to the rule(s) to be implemented by the rule engine 632 of the processing section 606. In step 1006, the processing section 606 evaluates the rule, or rules, as applicable, in view of the bag of facts and sends a rule-dependent response back to the application for further handling. As previously described, the rule(s) being evaluated by the processing section may involve forward-chaining, backward-chaining, or some combination thereof. In step 1108, the application 1002 processes the response and either sends an additional message or messages to the processing section 606 in view of the response, or sends data to the output for use by the users and/or other sources.

One example of an application for use with the processing section 606 involves duty time control. Many different occupations regulate the amount of time certain types of people can be on duty at one time, or over the course of a number of days, or per week or month, etc. Duty time control applications may be employed by hospitals to regulate the hours of doctors, nurses and other patient care providers, by government entities to regulate the amount of time that certain employees may work at one time, such as in the military, air traffic control, etc., or other industries, such as the airline industry, where it is necessary to control the amount of flying time (or other occupations) that different crew can put in over some period of time. When there are only a few individuals subject to such regulations, determining schedules for crew can be relatively easy, but when there are many thousands of crew members in many different time zones flying all over the world in different planes twenty-four hours a day, scheduling and properly controlling the duty time of crew can get very complicated; which is where the power of a rule engine in accordance with present embodiments can be fully realized.

A duty time control application for the airline industry is described below that helps to illustrate how embodiments of the present rule engine can be utilized for data-entry, screen configuration, authorization and other purposes. For example, a simple data-entry validation rule for use in conjunction with a graphical user interface (GUI) and that depends on the data model may be written as follows:
data(crew_person, I, P) and data(crew_person, J, P) and not I=J
   =>output(default, invalid(crew_person, “This crew member is already specified”));

Another data-entry validation rule that fires in the sign-off phase, after all data have been entered is as follows:
data(crew_function, _, “CMDR”)=>commander_assigned;
data(crew_function, _, “COPI”) and not commander_assigned
=>output(default, invalid(“FS2”, “A co-pilot may not be assigned without also assigning a commander”));
   The validation error is not associated with any single entry field, since it is possible to enter the crew members in any order, e.g. it is allowed to enter the co-pilot before entering the commander. But signing off with a co-pilot and no commander produces a validation error.

A screen configuration example is described next. In this example, a copy button in the same GUI data entry screen fills in default values for the departure and arrival airports for the return flight, using these rules:
copy(X) and data(X, Y)=>default(data(X,Y));
data(arrival, X)=>default(data(departure,X));
data(departure, X)=>default(data(arrival,X));

An authorization rule example might be written as follows:
view(movements)=>allow(all);
view(nonflight_activities)=>allow(all);
view(aeroplanes)=>allow(read);
role(postholder)=>allow(all);
allow(all)=>allow(read), allow(write), allow(signoff);
allow(X)=>output(default, allow(X));
   These rules are part of a non-persistent process of the rule engine that is called by the GUI code (a JAVA web application) with user roles and page view identifiers as input, and a rule engine output message returns a set of authorized operations for that user on that page. While there may be performance concerns in some situations that might make it more desirable to avoid this technique and use simple capability flags instead, but when this kind of flexible control over authorization is needed, the present rule engine can easily provide it. Due to the declarative semantics of the rule engine, the rule engine will even permit an untrusted user to upload rules for accessing personal data because there is no way the running of such rules could compromise the security of the rest of the system.

More sophisticated GUI applications that could be implemented using embodiments of the present rule engine include processes that react on individual user clicks and reconfigure GUI screens based on rules, the current process state, and optional messages from other processes.

A further example of an integration/configuration tool is illustrated below. The illustrative example describes a loan agreement application where the incoming message “generate_draft” causes the rule engine process to configure a draft generator service (a plugin application to the loan agreement application) to create the requested document. The configuration is performed by sending a message to a non-rule engine process “application”, which in this case may be part of the plugin. The rule code is as follows:

generate_draft

| and input(_, data(Key,Value)) | |
|---|---|
| and data_default(Key,Value,Value1) | |
| and template_path(Template) | |
| and draft_path(Draft) | |
| => | output(application, data(Key,Value1)), |
| | output(application, data(instance, “TEST”)), |
| | output(application, data(substColor, “007700”)), |
| | output(application, generate_draft(Template, Draft)); |

template_path(P) :=

if input(_, data(“CONVERTIBLE LOAN”, yes))
then P = “templates/Convertible Loan Agreement 2012.docx”
else P = “templates/Long Form Loan Agreement 2012.docx”;

P = “drafts”

| | |
|---|---|
| => | draft_folderpath(P), |
| | draft_path([P,“/Loan Agreement %s.docx”]); |

data_default(Key,“”,Value1) --> Value1=“[OMITTED]”;
data_default(Key,Value,Value1) --> Value1=Value;
generate_draft

| and input(_, data(“EXTERNAL APPROVAL”, yes)) | |
|---|---|
| => | persist(external_approval_required); |

Another example that demonstrates the power that comes from the rule engine's succinctness is more like a systems programming example than it is about configuration or integration. In this example, the rule engine rules implement a time scheduler, which is used in the duty time application described above to periodically update the current accumulated duty time and flight duty time hours for each crew member:
meta {use “file://library/crontab.rubble”;};
meta {use “file://library/mergesort-generic.rubble”; import lib::sort;};
input(_, start)=>start;
input(_, register(Pid, Pat))=>register(Pid, Pat);
input(_, unregister(Pid))=>unregister(Pid);
start and timer(Pid, T) and $TIME>=T=>output(Pid, cron(T));
start and timer(Pid, T)=>occlude(timer(Pid, T));
start and next_time(Pid, T)=>persist(timer(Pid, T));
start and findall(next_time, L) and sort(L, “<”, [T|_])
and not X̂timer(X, T) and eval(T-$TIME, D)
output(delayed(D,$PID), start);
next_time(Pid, T):=pattern(Pid, Pat), crontab::find_next_time(Pat, $TIME, T);
next_time(T):=next_time(_,T);
register(Pid, _) and pattern(Pid, Pat)=>occlude(pattern(Pid, Pat));
unregister(Pid) and pattern(Pid, Pat)=>occlude(pattern(Pid, Pat));
occlude(pattern(Pid, _) and timer(Pid, T)=>occlude(timer(Pid, T));
register(Pid, Pat)=>persist(pattern(Pid, Pat)), output($PID, start);
register(Pid, at(T))=>persist(timer(Pid, T));
pattern(Pid, at(T)) and output(Pid, cron(T))=>occlude(pattern(Pid, at(T)));
   The above lines of rule code implement a version of the Franta-Maly discrete event algorithm used by the UNIX “cron” service, which is used for time-scheduled batch jobs. The job tables used by “cron” are implemented by an additional 25 lines of code not shown here. In contrast, UNIX cron is implemented by about 5,000 lines of C code. Hence, the rule engine reduces the amount of code required to perform the same task by a factor of 100.

An embodiment of a document analysis application that utilizes the rule engine will now be described. This application runs on rule code for the rule engine and gives a user the ability to set up a DROPBOX type account where documents can be deposited in a cloud environment, and then analyzed to determine how each document should be processed based on the rule code. The documents could be of any type that have information associated with them, such as word processing documents, photos, emails, text messages, expense report, etc., but no instructions on how that information should be processed.

A workflow of logical rules would be established for processing the information included in a document once that document was placed in a location that associates the work flow with the document. A learning function may also be added so that user actions are studied over time and the work flow is modified, or the user is presented with options for modifying the work flow, so as to adapt to the user action. This type of document analysis application could be implemented mobile applications, business applications, or to simply automate everyday activities, such as dinner with friends, travel plans, etc. The application effectively adopts the concept of an Inbox/Outbox at the office and/or home that replaces the inefficient use of email to “get things done”. Rather than describe the rule code that would be required to implement the application, the work flow of the application will be described, with the understanding that a person of ordinary skill in the art would be able to implement the rule code using the syntax provided above, based on the logical construct of the work flow described herein.

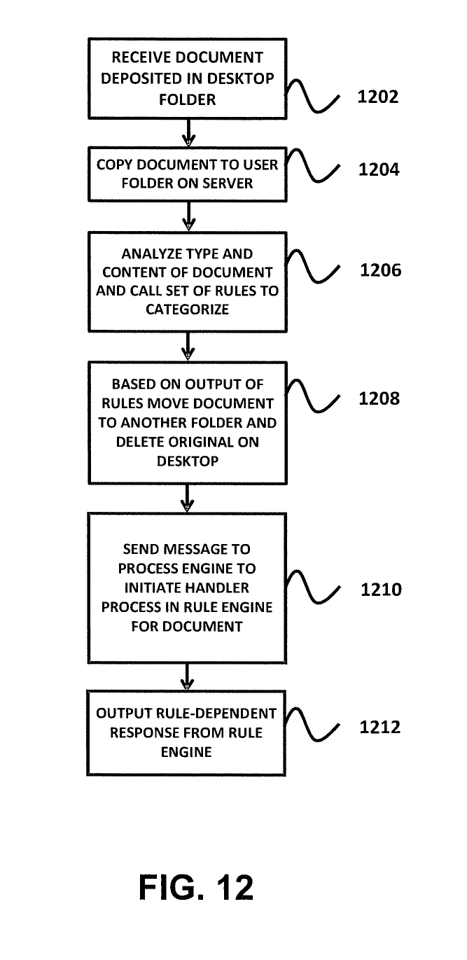

With reference now to FIG. 12, when a user drops a copy of a document in the application folder on the user's desktop, step 1202, the document is automatically copied to a corresponding folder assigned to the user on an application server, step 1204. When the document arrives at the server, an action is triggered automatically to run some JAVA code that looks at the document and its content and calls on a set of rules in rule code that categorize the document, step 1206. Based on the output from the categorization rules, the JAVA code then moves the document to another folder and deletes the copy from the application folder on the user's desktop, step 1208. The JAVA code then sends a message to the process engine's “handler” process to identify the handler processes or control flow processes to be implemented for the identified category of document, step 1210. Ideally, there is a single handler process for each different type of process identified as being necessary to process the document. When the document is done being processed, at least initially, by the process section 606, a rule-dependent response is output from the rule engine/processing section which initiates some work flow. In a business application, for example, there may be a handler for expense reports that starts a new workflow process for the received document unless a document with the same name is already associated with an active workflow process. Once the handler has been called, the next step in processing the information in that document depends on that specific handler, the identified workflow processes, and possibly the outcome of such processes.

For example, an email from a friend suggesting dinner on a particular date and time could be dropped by a user into a particular desktop folder for processing in accordance with various rule sets and work flows generated by the rule sets for creating a calendar event on the user's calendar for dinner on that date at that time, while a separate work flow accesses the website for a favorite restaurant and attempts to schedule a reservation for two on that date and time. When the reservation is made, the confirmation could be processed by a different rule set and a work flow could be generated so a copy is sent to the friend and a copy is stored in a folder created for the user with an appropriate identifier so the user can later find the confirmation if necessary. Depending on the set of rules, other work flows could be generated, such as the reservation of a car or sedan service for that evening, a message could be sent to the user as to whether any other special requests are needed for that evening, such as flowers to be ordered, a suit to be picked up from the cleaners, etc. The number and types of rules and work flows that could be established are endless, but would likely have some practical limitations for most people, and if the user did not want the same process to be followed, the user would not drop the email in the desktop folder to begin with or perhaps drop it into a different folder that would automatically apply a different set of rules.

The same type of process illustrated in FIG. 12 for personal or business productivity purposes could be used in many other contexts, such as the flight scheduling application, the duty time control application (with or without time scheduling), and the loan processing example described above. With respect to the later, in the processing of a loan, such as for a house purchase, there is typically a limited set of documents received from the loan applicant, generated by the potential lender, and obtained from other sources. The loan application, the applicant's financial records, information about the house, county records, credit rating reports, etc., could all be dropped into one or more folders for processing and would then be subject to a process similar to that described above. For example, the loan application would be analyzed to make sure all of the requested information was provided, and if not, work flows would be generated to obtain any missing information. Once all of the information was collected, all of the content would be analyzed to determine whether the applicant's information was within specified ranges for the size, type and terms of the loan, the value of the property, the purchase price, the down payment, etc. At the same time, other documents would be analyzed in a similar manner to make sure everything input met established criteria, and appropriate work flows would be generated based on whether such criteria was met or not. In the end, a response would be generated indicating whether the applicant qualified for the loan, whether there were issues that could be addressed that would allow the applicant to qualify, or whether the applicant had been denied and could not be made to qualify.

An example of an embodiment of a handler process that may be followed is a synchronous control flow where a JAVA program makes a call to a wrapper for the rule engine library that accepts a process channel designator P and a set of input data terms (facts). P is resolved to a database entry that contains a reference to some rule code (rules and facts) and a set of terms that represent the current process state. The latter terms are merged with the first input data terms, and then top level control flow, further described below, is performed, with the following additions: For every C,X for which output(C,X) is true, the message input(P,X) is sent to the process engine process designated by C. For every Y for which occlude(Y) is true, the term Y is deleted from the process state. Then for every Z for which persist(Z) is true, the term Z is added to the process state. The message sending and database update (if any) is done as a single JAVA EE transaction.

In another instance, an asynchronous control flow may be implemented in a manner similar to that described above for synchronous control flow, except that the channel designator and the input data terms (facts) are sent in a message to an asynchronous JAVA EE bean that handles the call, and performs the resulting transaction in the same transaction as the message reception. Any results from output(default,X) are discarded in this case.

The top-level control flow process involves a JAVA program making a call to the rule engine library, providing as arguments a text string containing rule code (rules and facts), and a set of input data terms (facts). The output is a set of terms containing X such that output(default,X) is true. If no exception occurs, this set is guaranteed to contain the largest such set that is entailed by the given rules and facts and input-term facts. The rule code text string can contain instructions to include other rule code modules, which are cached to increase efficiency. The rule code consists of three kinds of statements that are handled differently:
1. Forward-chaining rules.
2. Backward-chaining rules.
3. Facts.
   As further described below, the top-level call is performed by first applying the forward-chaining rules, and then applying the backward-chaining rules on the resulting program state.

Forward-chaining rules are applied by making a list of all the given facts (both those contained in the code and those supplied as input). Each fact is then removed from the list and applies to every forward-chaining rule that contains a condition matching that fact. The rule is then executed. If the rule produces an inference that was not already contained in the set of facts, that inference is added to the set of facts and to the end of the list. As described above with respect to FIG. 1, the forward-chaining rule can also be combined with execution of a backward-chaining rule.

Backward-chaining control flow involves a goal-term, possibly containing logic variables, being provided as input. If there is a backward-chaining rule that matches this goal-term, then backward-chaining deterministic control flow is applied. If the backward-chaining deterministic control flow algorithm terminates without leaving any choices in the proof tree, then a single solution for the goal-term is returned. Otherwise backward-chaining non-deterministic control flow is performed.

Backward-chaining deterministic control flow involves, as an initial step, creating an environment record with a slot for each logic variable present in the rule. Unify all variables in the rule head with the corresponding terms in the goal. If any unification results in the binding of any variable external to the newly created environment record, execution of this goal is suspended and the next goal is tried on the goal stack instead. If unification succeeds without suspension, all conditions in the rule guard (if any) are pushed onto the goal stack and the initial step is applied to them.

If a fact instead of a backward-chaining rule matches, the goal is solved if only one possible fact matched. Otherwise the goal is marked as an unresolved non-deterministic choice in the proof tree, and the goal is suspend as in the initial step.

If a built-in predicate matches, the corresponding JAVA code is invoked.

If unification fails, the current environment record is dropped and the next candidate (if any) is found from an if-then-else rule and the initial step is repeated.

When the rule guard has been solved (an empty guard is always solved), the rule body is committed by:
1. Cutting the “else” rule part from the candidates;
2. Merging the current environment record with the parent environment; and
3. Pushing the goals of the rule body onto the goal stack.

Any time a logical variable that belongs to a suspended goal is unified again (due to being present in multiple places), the suspended goal is placed on a “wake list” in the proof tree so it can be retried again at initial step.

Backward-chaining non-deterministic control flow involves finding the first unresolved choice in the proof tree (depth-first), and splitting the whole proof tree into T containing the first alternative of that choice and T′ containing a continuation choice-object that represents the remaining alternatives. The process then continues with the initial step of the deterministic control flow in T, and then in T′ (which can also be done in parallel).

With regard to the description above, the word “matching” has the specific meaning of Robinson-unification of Herbrand terms (possibly containing variables). The “occur check” of Robinson-unification is not done, for performance reasons. Instead, a limit is imposed on the depth of nested Herbrand terms so that attempts to unify too deeply nested terms cause an exception. Any situation that would have involved unification failure due to occur check will instead give rise to an exception.

Another type of application that may operate in conjunction with a processing section (i.e., process engine, database and rule engine) as described herein may involve various stages associated with the core radio frequency management, development, testing, performance analysis, and certification of a product. For example, during the development of certain types of electronic products, there are certain known steps that have to be followed regardless of the design or perhaps even certain features associated with the product. The known rules may have sets of rules established in association with them and work flows that are to be followed based on the rule-dependent outputs of the rule engine. These sets of rules and work flows may then be programmed into a company's internal product development system, or that system could be programmed to make calls or requests to a separate system that receives documents or data for processing by the processing section. For example, during design or conceptualization of a product, an engineer may upload simulation data associated with some aspect of the product being developed, and when the processing section receives this data, a workflow may be generated that causes a report to be generated based on the simulation data and a copy of the report to be sent to a manager for approval. If in processing the simulation data, it was determined that the simulation data was not correlating well with specification data or measured data, then different work flows may be generated that alert the manager, query the available schedules of the design team, and automatically sets up a meeting in conference room Z at time W.

Once the design/concept phase has been completed and the product moves into product development, different sets of rules and work flows may be applied. For example, sets of rules programmed into an application associated with the processing section may be used for early detection of potential problems. If the product is a new type of cellular phone, it may be necessary to send to the phone under development to a third party laboratory for certain testing. Such tests may take many weeks and cost a significant amount of money to complete. Measurement data generated during the tests may be sent to the application so that data can be analyzed in accordance with the rules in real-time or near real-time, and specific workflows may be generated as a result. If test number 10 out of some 600 tests generates measurement data that is strange, out of specification, indicates a failure, or even indicates something that will likely lead to a subsequent failure of other tests, in accordance with work flows, the testing may be stopped, or the customer requesting the tests may be sent a message and/or report alerting them to the issues and allowing them to stop the testing or to take some other action.

Once an electronic product to be sold in the United States, and many other countries, has been completed, it still has to pass certain standards requirements and regulatory rules, such as FCC regulations associated with radio frequency (RF) transmissions, before it can be sold to the public. These regulatory rules may be programmed into an application such that when raw measurement data is received, it is parsed, packaged and sent to a web service running in front of the processing section, which then checks the packaged data against its rules developed from the regulatory rules and responds with the appropriate work flow(s) to be followed. In an example of an embodiment, rule-dependent responses may be “pass” “fail” or “missing”, where “pass” means that of all the packaged parsed data passed the FCC regulations. The responses of “fail” or “missing” may be more complex, with a “fail” response also indication which of one or more parts that failed, or a “missing” response indicating which data was missing. Each of these responses may also have associated work flow, such that a “pass” response generates a report suitable for submission to the FCC, while the “failed” or “missing” response may generate different reports, including a listing of the failed or missing parts, the degree by which a part failed, computer generated information indicating where the failed part is located or the missing part should be located, such as by coloring text or part of a drawing of the parts or drawing a box around a failed or missing part in a certain color, etc.

In an embodiment, a system for constructing a set of rule code for use in a rule engine comprises a configurator configured to receive input data from a user without requiring the user to write the set of rule code and to format the input data to create formatted data, the input data including one or more process states of an application, one or more inputs that may be received at each of the one or more process states, one or more expected outputs of each of the one or more process states, and one or more actions to be performed at each of the one or more process states; and a rule writer configured to receive the formatted data and to generate the set of rule code that can be performed by the rule engine operating in conjunction with the application.

In the embodiment, the system further comprises a tester configured to receive the set of rule code from the rule writer and to perform a series of logical tests on the set of rules to verify that the set of rules will be capable of being performed by the rule engine, and configured to instruct the rule writer of any errors in the set of rules requiring correction.

In the embodiment, the system further comprises a form depository configured to receive a form from the user and to output the form to a data extractor configured to extract information from the form to develop the input data for the configurator.

In the embodiment, wherein the information extracted from the form includes one or more graphic objects and other information associated with the one or more graphic objects that identify the one or more process states, the one or more inputs, the one or more expected outputs, and the one or more actions.

In an embodiment, a method for performing a function of an application comprises the steps of receiving input to the application regarding the function from a user, one or more other sources or a combination of the user and the one or more other sources; determining one or more rules to apply to the function and a bag of facts associated with the one or more rules based on the input; sending a message to a rule engine containing the one or more rules and the bag of facts; processing the one or more rules and the bag of facts within the rule engine to develop a rule-dependent response associated with the function, wherein such processing includes combining a forward-chaining rule with a backward-chaining rule by creating a condition within the forward-chaining rule that contains a backward-chaining query; sending the rule-dependent response to the application; and performing one or more work flows within the application based on the rule-dependent response that result in performance of the function.

In an embodiment, a method for combining a backward-chaining rule with a forward-chaining rule within a rule engine comprises the steps of utilizing a fact inferred from the forward-chaining rule as a goal for the backward-chaining rule, unless the forward-chaining rule contains a condition that depends on negation of another forward-chaining inference, in which case execution of the forward-chaining rule is suspended, the dependency of the rule-predicate for the problematic fact is recorded in a table, and execution of the forward-chaining rule skips to the next untried fact to select a new rule to execute.

In an embodiment, a method for performing a function of an application comprises the steps of receiving input to the application regarding the function from a user, one or more other sources or a combination of the user and the one or more other sources; determining one or more rules to apply to the function and a bag of facts associated with the one or more rules based on the input; sending a message to a rule engine containing the one or more rules and the bag of facts; processing the one or more rules and the bag of facts within the rule engine to develop a rule-dependent response associated with the function, wherein such processing includes combining a backward-chaining rule with a forward-chaining rule by utilizing a fact inferred from the forward-chaining rule as a goal for the backward-chaining rule, unless the forward-chaining rule contains a condition that depends on negation of another forward-chaining inference, in which case execution of the forward-chaining rule is suspended, the dependency of the rule-predicate for the problematic fact is recorded in a table, and execution of the forward-chaining rule skips to the next untried fact to select a new rule to execute; sending the rule-dependent response to the application; and performing one or more work flows within the application based on the rule-dependent response that result in performance of the function.

In an embodiment, a method for processing a document for a user comprises the steps of receiving a document from a user in a document processing application; sending a message containing data from the document to a rule engine to initiate an identification process for the document; analyzing the document based on a first set of rules operated within the rule engine to produce a first rule-dependent response that identifies a document type and document content for the document; based on the first rule-dependent response, sending a message to the rule engine to initiate a handler process for the document based on the document type; analyzing the document content based on a second set of rules corresponding to the handler process to produce a second rule-dependent response; and based on the second rule-dependent response, performing one or more work flows within the document processing application to process the document.

In the embodiment, wherein the step of analyzing the document and the step of analyzing the document content includes combining a forward-chaining rule with a backward-chaining rule by creating a condition within the forward-chaining rule that contains a backward-chaining query.

In the embodiment, wherein the step of analyzing the document and the step of analyzing the document content includes combining a backward-chaining rule with a forward-chaining rule by utilizing a fact inferred from the forward-chaining rule as a goal for the backward-chaining rule, unless the forward-chaining rule contains a condition that depends on negation of another forward-chaining inference, in which case execution of the forward-chaining rule is suspended, the dependency of the rule-predicate for the problematic fact is recorded in a table, and execution of the forward-chaining rule skips to the next untried fact to select a new rule to execute.

In the embodiment, wherein the one or more work flows improve productivity of the user.

In the embodiment, wherein the document relates to a loan application, and wherein the second rule-dependent response approves the loan application, denies the loan application, or indicates additional documents or information is required to assess the loan application.

In an embodiment, a method for developing, testing and analyzing a product comprises the steps of receiving data regarding the product in an application; sending a message containing the data to a rule engine to initiate a process for analyzing the data; analyzing the data based on a set of rules operated within the rule engine to produce a rule-dependent response based on the data; and based on the rule-dependent response, performing one or more work flows within the application related to the development, testing or analysis of the product.

In the embodiment, wherein the step of analyzing the data includes combining a forward-chaining rule with a backward-chaining rule by creating a condition within the forward-chaining rule that contains a backward-chaining query.

In the embodiment, wherein the step of analyzing the data includes combining a backward-chaining rule with a forward-chaining rule by utilizing a fact inferred from the forward-chaining rule as a goal for the backward-chaining rule, unless the forward-chaining rule contains a condition that depends on negation of another forward-chaining inference, in which case execution of the forward-chaining rule is suspended, the dependency of the rule-predicate for the problematic fact is recorded in a table, and execution of the forward-chaining rule skips to the next untried fact to select a new rule to execute.

In the embodiment, wherein the data is simulation data associated with an aspect of the product being developed, wherein the rule-dependent response indicates a problem with the simulation data, and wherein the one or more work flows include alerting one or more persons regarding the problem.

In the embodiment, wherein the data is testing data associated with a prototype of the product being developed, wherein the rule-dependent response indicates a problem with the testing data, and wherein the one or more work flows include alerting one or more persons regarding the problem.

In the embodiment, wherein the data is analysis data associated with the product that has been developed, wherein the rule-dependent response indicates the product passes a certification, fails a certification, or is missing a part necessary to certifying the product in accordance with a standard or a regulation, and wherein the one or more work flows include alerting one or more persons regarding the product passing the certification, failing the certification or missing the part.

In the embodiment, wherein one or more work flows include generating a report suitable for submission to a standard body or regulatory authority.

In the embodiment, wherein one or more work flows include generating a report indicating why the product failed the certification.

In the embodiment, wherein one or more work flows include generating a report indicating at least one part the product was missing and an indication of where the part could be located within the product.

In an embodiment, a method for assisting a user in selecting an airplane flight comprises the steps of receiving data within an application from the user regarding the user's preferences for the airplane flight; sending a message containing the data to a rule engine to initiate a process for analyzing the data; analyzing the data based on a set of rules operated within the rule engine to produce a rule-dependent response based on the data; and based on the rule-dependent response, performing one or more work flows within the application related to identifying one or more airplane flights that meet the user's preferences.

In the embodiment, wherein the step of analyzing the data includes combining a forward-chaining rule with a backward-chaining rule by creating a condition within the forward-chaining rule that contains a backward-chaining query.

In the embodiment, wherein the step of analyzing the data includes combining a backward-chaining rule with a forward-chaining rule by utilizing a fact inferred from the forward-chaining rule as a goal for the backward-chaining rule, unless the forward-chaining rule contains a condition that depends on negation of another forward-chaining inference, in which case execution of the forward-chaining rule is suspended, the dependency of the rule-predicate for the problematic fact is recorded in a table, and execution of the forward-chaining rule skips to the next untried fact to select a new rule to execute.

In an embodiment, a method for monitoring crew members associated with an airline comprises the steps of receiving data within an application regarding each crew member; sending a message containing the data to a rule engine to initiate a process for analyzing the data; analyzing the data based on a set of rules operated within the rule engine to produce a rule-dependent response based on the data; and based on the rule-dependent response, performing one or more work flows within the application related to identifying one or more airplane flights that meet duty time requirements for the crew member.

In the embodiment, wherein the step of analyzing the data includes combining a forward-chaining rule with a backward-chaining rule by creating a condition within the forward-chaining rule that contains a backward-chaining query.

In the embodiment, wherein the step of analyzing the data includes combining a backward-chaining rule with a forward-chaining rule by utilizing a fact inferred from the forward-chaining rule as a goal for the backward-chaining rule, unless the forward-chaining rule contains a condition that depends on negation of another forward-chaining inference, in which case execution of the forward-chaining rule is suspended, the dependency of the rule-predicate for the problematic fact is recorded in a table, and execution of the forward-chaining rule skips to the next untried fact to select a new rule to execute.

In the embodiment, wherein the one or more work flows identify a work schedule for the crew member.

A number of computing systems have been described throughout this disclosure. The descriptions of these systems are not intended to limit the teachings or applicability of this disclosure. Further, the processing of the various components of the illustrated systems may be distributed across multiple machines, networks, and other computing resources. For example, components of the rule engine, process engine, database and corresponding applications may be implemented as separate devices or on separate computing systems, or alternatively as one device or one computing system. In addition, two or more components of a system may be combined into fewer components. Further, various components of the illustrated systems may be implemented in one or more virtual machines, rather than in dedicated computer hardware systems. Likewise, the databases and other storage locations shown may represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown may communicate with any other subset of components in various implementations.

Depending on the embodiment, certain acts, events, or functions of any of the algorithms described herein may be performed in a different sequence, may be added, merged, or left out altogether (e.g., not all described acts or events are necessary for the practice of the algorithms). Moreover, in certain embodiments, acts or events may be performed concurrently, e.g., through multi-threaded processing, interrupt processing, or multiple processors or processor cores or on other parallel architectures, rather than sequentially.

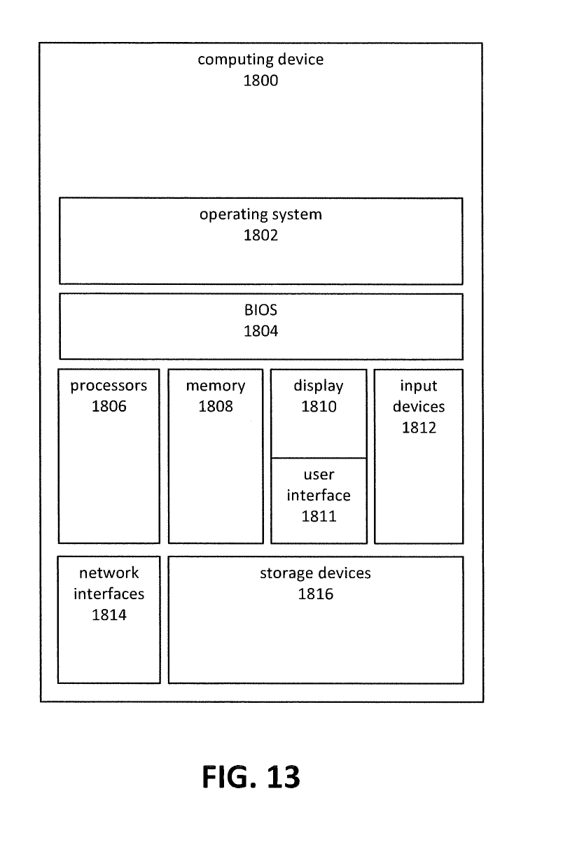

As further discussed below with respect to FIG. 13, each of the various illustrated systems may be implemented as a computing system that is programmed or configured to perform the various functions described herein. The computing system may include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry of the computer system. Where the computing system includes multiple computing devices, these devices may, but need not, be co-located. The results of the disclosed methods and tasks may be persistently stored by transforming physical storage devices, such as solid state memory chips and/or magnetic disks, into a different state. Each application described herein may be implemented by one or more computing devices, such as one or more physical servers programmed with associated server code or in a client-server arrangement.

FIG. 13 depicts an embodiment of an exemplary implementation of a computing device 1800 suitable for practicing aspects of the present disclosure. Computing device 1800 may be configured to perform various functions described herein by executing instructions stored on memory 1808 and/or storage device 1816. Various examples of computing devices include personal computers, cellular telephones, smartphones, tables, workstations, servers, and so forth. Embodiments may also be practiced on distributed computing systems comprising multiple computing devices communicatively coupled via a communications network.

One or more processors 1806 includes any suitable programmable circuits including one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above example embodiments are not intended to limit in any way the definition and/or meaning of the term “processor.”

Memory 1808 and storage devices 1816 include non-transitory computer readable storage mediums such as, without limitation but excluding signals per se, random access memory (RAM), flash memory, a hard disk drive, a solid state drive, a diskette, a flash drive, a compact disc, a digital video disc, and/or any suitable memory. In the exemplary implementation, memory 1808 and storage device 1816 may include data and/or instructions embodying aspects of the disclosure that are executable by processors 1806 (e.g., processor 1806 may be programmed by the instructions) to enable processors 1806 to perform the functions described herein. Additionally, memory 1808 and storage devices 1816 may comprise an operation system 1802, basic input-output system (“BIOS”) 1804, and various applications.

Display 1810 includes at least one output component for presenting information to a user of the computing device and may incorporate a user interface 1811 for providing interactivity through the display 1810. Display 1810 may be any component capable of conveying information to a user of the computing device. In some implementations, display 1810 includes an output adapter such as a video adapter and/or an audio adapter or the like. An output adapter is operatively coupled to processor 1806 and is configured to be operatively coupled to an output device such as a display device (e.g., a liquid crystal display (LCD), organic light emitting diode (OLED) display, cathode ray tube (CRT), “electronic ink” display, or the like) or an audio output device (e.g., a speaker, headphones, or the like).

Input Devices 1812 includes at least one input component for receiving input from a user. Input component 1812 may include, for example, a keyboard, a pointing device, a mouse, a stylus, a touch sensitive panel (e.g., a touch pad or a touch screen incorporated into the display 1810), a gyroscope, an accelerometer, a position detector, an audio input device, or the like. A single component such as a touch screen may function as both an input device 1812 and a display 1810.

Network interfaces 1814 may comprise one or more devices configured to transmit and receive control signals and data signals over wired or wireless networks. In various embodiments, one or more of network interfaces 1814 may transmit in a radio frequency spectrum and operate using a time-division multiple access (“TDMA”) communication protocol, wideband code division multiple access (“W-CDMA”), and so forth. In various embodiments, network interfaces 1814 may transmit and receive data and control signals over wired or wireless networks using Ethernet, 802.11, internet protocol (“IP”) transmission, and so forth. Wired or wireless networks may comprise various network components such as gateways, switches, hubs, routers, firewalls, proxies, and so forth.

Conditional language used herein, such as, among others, “may,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated may be made without departing from the spirit of the disclosure. As will be recognized, the processes described herein may be embodied within a form that does not provide all of the features and benefits set forth herein, as some features may be used or practiced separately from others. The scope of protection is defined by the appended claims rather than by the foregoing description. All changes which come within the meaning and range of equivalency of the claims are to be embraced within their scope.

1. A system for constructing a set of rule code for use in a rule engine, comprising:
a configurator configured to receive input data from a user without requiring the user to write the set of rule code and to format the input data to create formatted data, the input data including one or more process states of an application, one or more inputs that may be received at each of the one or more process states, one or more expected outputs of each of the one or more process states, and one or more actions to be performed at each of the one or more process states; and
a rule writer configured to receive the formatted data and to generate the set of rule code that can be sent together to and performed by the rule engine operating in conjunction with the application, the set of rule code including one or more rules that apply to a bag of facts containing data this is true for the one or more rules for a current process state among the one or more process states and without requesting additional rules or additional data for the one or more rules from any source during the current process state.

2. The system as recited in claim 1, further comprising a tester configured to receive the set of rule code from the rule writer and to perform a series of logical tests on the set of rules to verify that the set of rules will be capable of being performed by the rule engine, and configured to instruct the ride writer of any errors in the set of rules requiring correction.

3. The system as recited in claim 1, further comprising:
a form depository configured to receive a form from the user and to output the form to a data extractor configured to extract information from the form to develop the input data for the configurator.

4. The system as recited in claim 3, wherein the information extracted from the form includes one or more graphic objects and other information associated with the one or more graphic objects that identify the one or more process states, the one or more inputs, the one or more expected outputs, and the one or more actions.

5-28. (canceled)
